(19) United States
(12) Patent Application Publication
(10) Pub. No.: US 2026/0208612 A1
(43) Pub. Date: Jul. 23, 2026

(54) BI-LEVEL OPTIMIZATION METHOD AND DEVICE BASED ON TRUCK MOBILE CHARGING STATION LEASING MODE

(71) Applicants: Tianjin University, Tianjin (CN); Lanzhou Jiaotong University, Lanzhou (CN)

(72) Inventors: Hongjie Jia, Tianjin (CN); Kecheng He, Lanzhou (CN); Yunfei Mu, Tianjin (CN); Guangwu Chen, Lanzhou (CN); Xiaolong Jin, Tianjin (CN); Xiandong Xu, Tianjin (CN); Yue Zhou, Tianjin (CN)

(21) Appl. No.: 19/457,034

(22) Filed: Jan. 22, 2026

(30) Foreign Application Priority Data
Jan. 23, 2025 (CN) 202510106396.6

(51) Int. Cl. B60L 53/64; B60L 53/53; B60L 53/62; B60L 53/67; G06Q 50/06

(52) U.S. Cl. CPC B60L 53/64; B60L 53/53; B60L 53/62; B60L 53/67; G06Q 50/06

(57) ABSTRACT

A bi-level optimization (BLO) method based on a truck mobile charging station (TMCS) leasing mode includes the steps of: establishing a bi-level game model based on a TMCS leasing mode; introducing a Wasserstein distance distributionally robust model based on chance constraints through a distributionally robust optimization (DRO) strategy; balancing economy and robustness of the bi-level game model via the Wasserstein distance distributionally robust model; solving a TMCS operator (TMCO) model through a genetic algorithm (GA) to obtain a revenue-maximizing configuration and a leasing price; and solving a charging facility operator (CFO) two-stage distributionally robust chance-constrained optimization (DRCC) model via a nested column-and-constraint generation (NC&CG) algorithm to obtain a leasing plan and a scheduling strategy with maximum utility. Demands of various operators can be effectively balanced, which can improve the economy of CFOs while ensuring the revenue of TMCOs.

### CROSS-REFERENCE TO RELATED APPLICATION

This application claims priority of Chinese Patent Application No. 202510106396.6, filed on Jan. 23, 2025, the entire contents of which are incorporated herein by reference.

### TECHNICAL FIELD

The present disclosure relates to the technical field of charging facility optimization, and in particular to a bi-level optimization (BLO) method and device based on a truck mobile charging station (TMCS) leasing mode.

### BACKGROUND

The emerging TMCS integrates a certain number of charging piles and energy storage battery packs into containers loaded by trucks. As an effective supplement to traditional fixed charging facilities, TMCS is more flexible and scalable than fixed charging stations (FCSs). However, the commercial operation of TMCS still faces challenges including high initial cost and low utilization rate, which hinder motivation and participation of operators.

Currently, charging facility operators (CFOs) typically employ two main business models. The first model is “self-build”, which operators invest and manage charging stations themselves, such as companies including Tesla in the United States, NIO and Star Charge in China. This model usually involves high investment costs, but operators have complete control over operations and the profits. The second model is called the “owner-operator” model, in which owners provide charging facilities and outsourcing services to operators, such as companies including EVgo. This model allows owners to secure revenue while transferring operational risks to operators, who face uncertainties in charging demand and revenue. Meanwhile, operators can expand their charging services without incurring substantial upfront investments. Although the above-mentioned business models already exist in the field of charging facilities, the adoption of TMCS still faces unique challenges. Since TMCS is mainly used as a temporary supplement to fixed charging facilities, this supporting role increases the difficulty of its adoption and application. TMCS operators (TMCOs) often face high initial costs, long payback periods, and uncertain demands. These challenges may affect operator profits and the further adoption of TMCS.

Therefore, developing an optimization method based on TMCS leasing model that effectively balances the demands of various operators, and improve the economics of CFOs while ensuring the revenue of TMCOs has become an urgent issue requiring solved.

### SUMMARY

Therefore, the present disclosure provides a BLO method and device based on a TMCS leasing mode, which can effectively balance the demands of various operators, and improve the economics of CFOs while ensuring the revenue of TMCOs through adaptive pricing and resource allocation strategies.

To achieve the above objective, the present disclosure provides the following technical solutions. A BLO method based on a TMCS leasing mode includes the steps of:
establishing a bi-level game model based on a TMCS leasing mode, the bi-level game model including a TMCO model and a CFO two-stage distributionally robust chance-constrained optimization (DRCC) model;
introducing a Wasserstein distance distributionally robust model based on chance constraints through a distributionally robust optimization (DRO) strategy; and balancing economy and robustness of the bi-level game model via the Wasserstein distance distributionally robust model; and
solving the TMCO model through a genetic algorithm (GA) to obtain a revenue-maximizing configuration and a leasing price; and solving the CFO two-stage DRCC model via a nested column-and-constraint generation (NC&CG) algorithm to obtain a leasing plan and a scheduling strategy with maximum utility.

In a preferred solution of the BLO method based on a TMCS leasing mode, the optimization objective of the TMCO model is to maximize net revenue, and parameters of the TMCO model include:

leasing income of TMCS; a revenue function of TMCO, representing a difference between a total income from leasing and energy arbitrage and costs of investment, operation and maintenance, and losses; profit of TMCS from energy arbitrage; investment and operation and maintenance costs of TMCS; set of TMCS, as well as subsets for short-term leasing and long-term leasing; leasing period and planning cycle; number ω and total quantity of TMCS; energy storage battery cost, energy storage battery replacement cost, charging pile and converter cost, cost of other accessories for trucks and containers, garage cost, and operation and maintenance cost of TMCS ω; conversion coefficients for TMCS system, energy storage batteries, and maintenance costs; service life of energy storage batteries and TMCS system; discount rate converted to the planning cycle; and replacement serial number and total replacement times of the energy storage batteries; and
operational constraint parameters of the TMCO model include:
dispatching time and a dispatching cycle; maximum configuration quantity of TMCS determined by a budget of TMCO; price ceiling determined by self-owned cost and leasing preference of CFO j (where j is the number of CFO); self-owned amortization cost converted to the dispatching cycle; adjustment coefficient; electricity price per kilowatt-hour when TMCS returns to a warehouse for recharging; node electricity price for TMCS participating in a day-ahead electricity energy market for energy arbitrage; operating location of TMCS, i.e., an energy arbitrage node interacting with a power grid; charging and discharging power of TMCS ω at a time th for a node n; service end time of TMCS and corresponding garage; total travel distance in a dispatching period; average driving speed of TMCS; energy consumption per kilometer of TMCS; labor cost of TMCS co; marginal aging cost of TMCS life cycle; calendar aging parameter of TMCS battery pack; annual serial number corresponding to commissioning of TMCS; maximum charging and discharging power; charging and discharging efficiency of TMCS; capacity of TMCS ω; state of charge (SOC) value of TMCS at the dispatching time; and maximum and minimum SOC values of TMCS.

In a preferred solution of the BLO method based on a TMCS leasing mode, an optimization objective of the CFO two-stage DRCC model is to maximize utility; and parameters of the CFO two-stage DRCC model include:
utility function of CFO j, defined as maximizing the profit of operator while ensuring charging service quality requirements; set of TMCS for CFO j, as well as subsets for short-term leasing and long-term leasing; electric vehicle (EV) charging demand at a node m when selecting TMCS for charging; ambiguity set of charging demand; optimization variables; EV charging service revenue; TMCS leasing cost; TMCS operating cost; EV charging electricity fee; charging and discharging power of TMCS ω at the time th between nodes n and m; corresponding road network EV charging service nodes; and TMCS driving distance obtained by the shortest path method; and
constraint parameters of the CFO two-stage DRCC model include:
total number of leased units of CFO j at t; maximum output power of TMCS ω when providing EV charging services, determined by the number of charging piles and rated power of TMCS; and EV charging demand response ratio of CFO j, reflecting charging service quality preference of CFO.

In a preferred solution of the BLO method based on a TMCS leasing mode, in a process of solving the CFO two-stage DRCC model by the NC&CG algorithm, a solution problem of the CFO two-stage DRCC model is converted into a master problem (MP) and a subproblem (SP).

In a preferred solution of the BLO method based on a TMCS leasing mode, in a process of solving the SP, the SP is decomposed into a master problem subset (MPS) and a subproblem subset (SPS).

The present disclosure also provides a BLO device based on a TMCS leasing mode, which adopts the above-described BLO method based on a TMCS leasing mode, and includes:
a bi-level game model construction module, configured to establish a bi-level game model based on a TMCS leasing mode; and the bi-level game model including a TMCO model and a CFO two-stage DRCC model;
a Wasserstein distance distribution robust model processing module, configured to introduce a Wasserstein distance distributionally robust model based on chance constraints through a DRO strategy; and balance economy and robustness of the bi-level game model via the Wasserstein distance distributionally robust model; and
a bi-level game model solving module, configured to solve the TMCO model through a GA to obtain a revenue-maximizing configuration and a leasing price; and solve the CFO two-stage DRCC model via an NC&CG algorithm to obtain a leasing plan and a scheduling strategy with maximum utility.

In a preferred solution of the BLO device based on a TMCS leasing mode, in the bi-level game model construction module, the optimization objective of the TMCO model is to maximize net income; and parameters of the TMCO model include:
leasing income of TMCS; a revenue function of TMCO, representing a difference between a total income from leasing and energy arbitrage and costs of investment, operation and maintenance, and losses; profit of TMCS from energy arbitrage; investment and operation and maintenance costs of TMCS; set of TMCS, as well as subsets for short-term leasing and long-term leasing; leasing period and planning cycle; number ω and total quantity of TMCS; energy storage battery cost, energy storage battery replacement cost, charging pile and converter cost, cost of other accessories for trucks and containers, garage cost, and operation and maintenance cost of TMCS ω; conversion coefficients for TMCS system, energy storage batteries, and maintenance costs; service life of energy storage batteries and TMCS system; discount rate converted to the planning cycle; and replacement serial number and total replacement times of the energy storage batteries; and
operational constraint parameters of the TMCO model include:
dispatching time and a dispatching cycle; maximum configuration quantity of TMCS determined by a budget of TMCO; price ceiling determined by self-owned cost and leasing preference of CFO j (where j is the number of CFO); self-owned amortization cost converted to the dispatching cycle; adjustment coefficient; electricity price per kilowatt-hour when TMCS returns to a warehouse for recharging; node electricity price for TMCS participating in a day-ahead electricity energy market for energy arbitrage; operating location of TMCS, i.e., an energy arbitrage node interacting with a power grid; charging and discharging power of TMCS ω at a time th for a node n; service end time of TMCS and corresponding garage; total travel distance in a dispatching period; average driving speed of TMCS; energy consumption per kilometer of TMCS; labor cost of TMCS ω; marginal aging cost of TMCS life cycle; calendar aging parameter of TMCS battery pack; annual serial number corresponding to commissioning of TMCS; maximum charging and discharging power; charging and discharging efficiency of TMCS; capacity of TMCS ω; SOC value of TMCS at the dispatching time; and maximum and minimum SOC values of TMCS.

In a preferred solution of the BLO device based on a TMCS leasing mode, in the bi-level game module, the optimization objective of the CFO two-stage DRCC model is to maximize utility; and parameters of the CFO two-stage DRCC model include:
utility function of CFO j, defined as maximizing the profit of operator while ensuring charging service quality requirements; set of TMCS for CFO j, as well as subsets for short-term leasing and long-term leasing; EV charging demand at a node m when selecting TMCS for charging; ambiguity set of charging demand; optimization variables; EV charging service revenue; TMCS leasing cost; TMCS operating cost; EV charging electricity fee; charging and discharging power of TMCS ω at the time th between nodes n and m; corresponding road network EV charging service nodes; and TMCS driving distance obtained by the shortest path method; and
constraint parameters of the CFO two-stage DRCC model include:
total number of leased units of CFO j at t; maximum output power of TMCS ω when providing EV charging services, determined by the number of charging piles and rated power of TMCS; and EV charging demand response ratio of CFO j, reflecting charging service quality preference of CFO.

In a preferred solution of the BLO device based on a TMCS leasing mode, in the bi-level game model solving module, in a process of solving the CFO two-stage DRCC model by the NC&CG algorithm, a solution problem of the CFO two-stage DRCC model is converted into a MP and a SP.

In a preferred solution of the BLO device based on a TMCS leasing mode, in the bi-level game model solving module, in a process of solving the SP, the SP is decomposed into a MPS and an SPS.

The present disclosure has the following advantages. In the present disclosure, a bi-level game model is constructed based on a TMCS leasing mode; and the bi-level game model includes a TMCO model and a CFO two-stage DRCC model. A Wasserstein distance distributionally robust model based on chance constraints is introduced through a DRO strategy; and economy and robustness of the bi-level game model are balanced via the Wasserstein distance distributionally robust model. The TMCO model is solved through a GA to obtain a revenue-maximizing configuration and a leasing price; and the CFO two-stage DRCC model is solved via an NC&CG algorithm to obtain a leasing plan and a scheduling strategy with maximum utility. In the present disclosure, a BLO method framework based on a TMCS leasing mode is provided. An upper layer aims to maximize the revenue of TMCOs. TMCOs set long-term and short-term leasing packages according to differences in leasing demand, balance and determine leasing prices for different participants and the configuration quantity of TMCS, and schedule TMCS to participate in grid energy arbitrage in idle periods. A lower layer, with the objective of maximizing the utility of CFOs, responds to the leasing packages and feeds back the leasing quantity and leasing duration. In the present disclosure, the DRO method is adopted to introduce a Wasserstein DRCC model to fully consider the influence of charging prediction information error on optimization results. In the present disclosure, based on a conditional value-at-risk (CVaR) approximation method, the upper and lower layers of the model are solved using the GA and NC&CG algorithm. Through adaptive pricing and resource allocation strategies, the present disclosure can effectively balance the demands of TMCOs and CFOs, ensuring the profitability of TMCOs while improving the economy of CFOs.

### BRIEF DESCRIPTION OF THE DRAWINGS

To more clearly explain the embodiments of the present disclosure or the technical solutions in the related art, the accompanying drawings required in the description of the embodiments or the related art are introduced briefly below. Obviously, the drawings in the following description are only exemplary, and other accompanying drawings can be obtained according to these drawings without creative efforts for those ordinary skilled in the art.

The structures, proportions, sizes, etc., illustrated in the present specification are only used to match the contents disclosed in the present specification and to be understood and read by those skilled in the art, and are not used to limit the conditions under which the present disclosure can be implemented, and therefore have no technical substantive significance. Any structural modification, change of proportional relationship, or size adjustment are still to be fell within the scope of the technical contents disclosed in the present disclosure without affecting the effects and objectives that the present disclosure can be achieved.

FIG. 1 is a schematic flow diagram of a BLO method based on a TMCS leasing mode provided in Example 1 of the present disclosure.

FIG. 2 is a schematic diagram of a specific implementation framework of the BLO method based on a TMCS leasing mode provided in Example 1 of the present disclosure.

FIG. 3 is a schematic diagram of a model solution flow of the BLO method based on a TMCS leasing mode provided in Example 1 of the present disclosure.

FIG. 4 is a schematic diagram of distribution of a ring-form highway network and operating locations of FCSs of various operators in a possible example provided in Example 1 of the present disclosure.

FIG. 5A is a schematic diagram for comparing the number of TMCS and leasing prices of various operators under different working conditions in a possible example provided Example 1 of the present disclosure.

FIG. 5B is a schematic diagram for comparing costs and profits of various operators under different working conditions in a possible example provided Example 1 of the present disclosure.

FIG. 6A is a schematic diagram of charging demand distribution on Typical Day 1 in a possible example provided in Example 1 of the present disclosure.

FIG. 6B is a schematic diagram of TMCS operating status on Typical Day 1 in a possible example provided in Example 1 of the present disclosure.

FIG. 6C is a schematic diagram of charging demand distribution on Typical Day 2 in a possible example provided in Example 1 of the present disclosure.

FIG. 6D is a schematic diagram of TMCS operating status on Typical Day 2 in a possible example provided in Example 1 of the present disclosure.

FIG. 7 is a schematic diagram of a BLO device architecture based on a TMCS leasing model provided in Example 2 of the present disclosure.

### DETAILED DESCRIPTION

Embodiments of the present disclosure will be described below with reference to specific examples, and those skilled in the art can easily understand the other advantages and effects of the present disclosure from the content disclosed in this specification. Obviously, the examples described are some examples of the present disclosure, but not all examples. Based on the examples in the present disclosure, all other examples obtained by those ordinary skilled in the art without creative efforts belong to the scope of protection of the present disclosure.

### Example 1

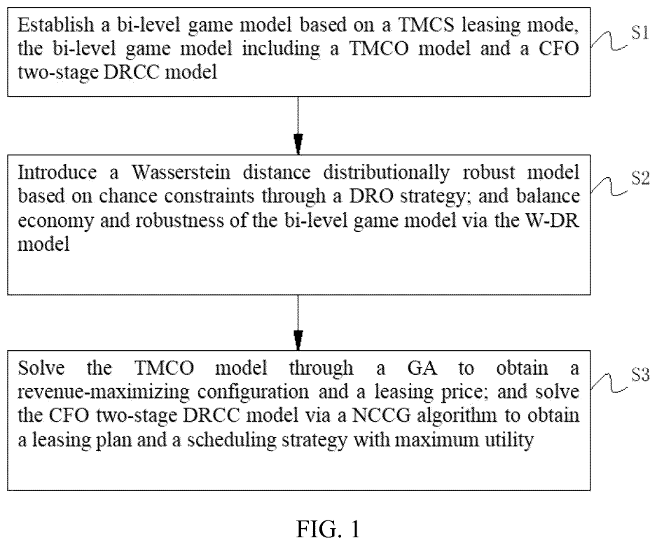

Referring to FIG. 1, Example 1 of the present disclosure provides a BLO method based on a TMCS leasing mode, including the following steps.

In S1, a bi-level game model is constructed based on a TMCS leasing mode; and the bi-level game model includes a TMCO model and a CFO two-stage DRCC model.

In S2, a Wasserstein distance distribution robust model based on chance constraint is introduced through the distributed robust optimization strategy; and the economy and robustness of the bi-level game model are balanced by the Wasserstein distance distribution robust model.

In S3, the TMCO model is solved through a GA to obtain a revenue-maximizing configuration and a leasing price; and the CFO two-stage DRCC model is solved via an NC&CG algorithm to obtain a leasing plan and a scheduling strategy with maximum utility.

In this example, in S1, a bi-level game model is constructed based on a TMCS leasing mode; and the bi-level game model includes a TMCO model and a CFO two-stage DRCC model.

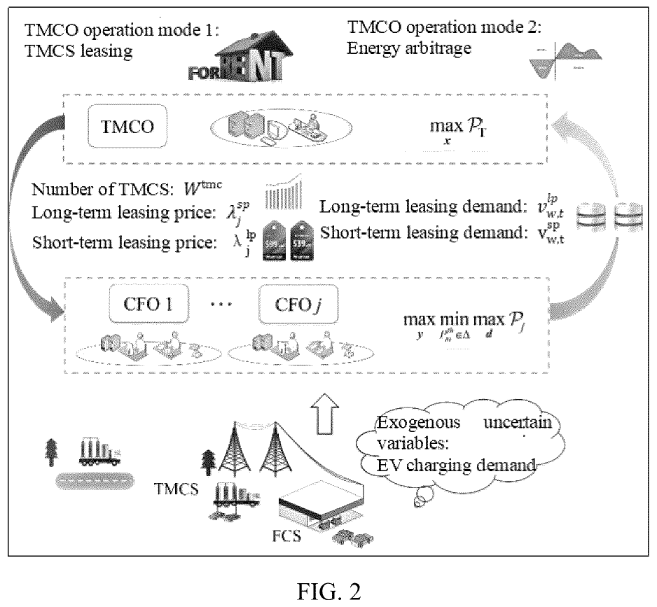

Specifically, a framework of the bi-level game model is shown in FIG. 2, which is called a “supplier-lessee” model. CFOs, as lessees, usually have a certain number of FCSs, and due to the rapid growth of EV charging demand and tidal characteristics thereof, CFOs may face a shortage of charging facilities in some scenarios. TMCO invests and owns TMCS as a supplier, leasing the TMCS to the CFO to provide EV charging services. This allows the TMCO to focus on asset ownership and equipment maintenance while the CFO can scale up operations without significant initial costs.

To meet the differentiated demands of CFOs, TMCO offers a choice of long-term and short-term leasing packages and adjusts the package price and configuration of TMCS based on CFO feedback. Idle TMCS can act as price takers in the electricity spot market and participate in energy arbitrage by connecting to the distribution network to obtain additional profits. Through an embedded two-stage DRCC, the model can adapt to uncertain EV charging demands and improve the utilization of TMCS. Based on Starkelberg's game theory, the above process can be expressed as follows:

$$L = \{ ( J ⋃ \{ TMCO \} ) , {\{ {X}_{j} \}}_{j ∈ J} , \{ {X}_{T} \} , {\{ {P}_{j} \}}_{j ∈ J} , {P}_{T} \} \qquad ( 1 )$$

where a set J represents a set of CFOs, CFOs act as followers and select the optimal package based on a leasing price set by a game leader TMCO; Xⱼ is a strategy set of CFO j, including the number of TMCS selected for long-term leasing and short-term leasing and a leasing period

$$( {v}_{w , t}^{sp} , {v}_{w , t}^{lp} ) ;$$

j is a code for the CFO; X_{T} is a set of strategies by TMCO, including the number of TMCS configurations (W^{tmc}) and the set package prices of the long-term leasing and short-term leasing

$$( {λ}_{j}^{lp} , {λ}_{j}^{s p} ) ;$$

Pⱼ is a utility function of CFO j, which maximizes the profit of the operator while ensuring the quality requirements of charging services; and P_{T} is a revenue function of TMCO, representing a difference between a total revenue from leasing and energy arbitrage and costs of investment, operation and maintenance, wear and losses.

Through the strategies chosen by each subject, the objectives of CFO and TMCO are to maximize the utility and profit thereof. Therefore, a feasible solution of the game is Stackelberg equilibrium (SE), that is, the leader obtains the optimal price through the best game of the followers, and the followers decide the optimal leasing combination. In the equilibrium state, any participant cannot get better results by unilaterally changing its strategy.

In this example, the bi-level game model includes the TMCO model and the CFO two-stage DRCC model.

The optimization objective of the TMCO model is to maximize the net income; and an expression of the TMCO model is:

$$\{ \begin{matrix}\begin{matrix}max \\ x\end{matrix} {P}_{T} = {\sum }_{t ϵ T} ( {I}_{ω , t}^{L} + {v}_{ω , t}^{e a} {P}_{ω , t}^{e a} ) - {C}^{I O M} \\ x = [ {λ}_{j}^{sp} , {λ}_{j}^{lp} , {W}^{tmc} , {v}_{ω , t}^{e a} ] \\ ω ∈ {Ω}_{J}^{L} = \{ {Ω}_{J}^{sp} ⋃ {Ω}_{J}^{lp} \}\end{matrix} \qquad ( 2 a )$$

$${I}_{ω , t}^{L} = {\sum }_{ω ϵ {Ω}_{J}^{s p}} {v}_{ω , t}^{sp} {λ}_{j}^{sp} + {\sum }_{ω ϵ {Ω}_{J}^{lp}} {v}_{ω , t}^{lp} {λ}_{j}^{lp} \qquad ( 2 b )$$

$${C}^{I O M} = {\sum }_{ω} [ {η}^{s} ( {c}_{ω}^{p l} + {c}_{ω}^{tk} ) + {η}^{b} ( {c}_{ω}^{b t} + {η}^{b , f} {c}_{ω}^{b , f} ) + {η}^{m t} {c}_{ω}^{m t} ] + {η}^{s} {c}^{dp}$$

$$\{ \begin{matrix}{η}^{s} = {{r}_{0}^{T} ( 1 + {r}_{0}^{T} )}^{{K}^{s}} / [ {( 1 + {r}_{0}^{T} )}^{{K}^{s}} - 1 ] \\ {η}^{b} = {{r}_{0}^{T} ( 1 + {r}_{0}^{T} )}^{{K}^{b}} / [ {( 1 + {r}_{0}^{T} )}^{{K}^{b}} - 1 ] \\ {η}^{b , f} = {\sum }_{{r}^{c} = 1}^{{N}^{r c}} 1 / {( 1 + {r}_{0}^{T} )}^{{r}^{{c}_{K} b}} \\ {η}^{m t} = 1 / {( 1 + {r}_{0}^{T} )}^{{K}^{s}}\end{matrix} \qquad ( 2 c )$$

$$where$$

$${I}_{ω , t}^{L}$$

is a leasing revenue of TMCSs; P_{T} is a revenue function of TMCO, representing the difference between the total revenue from leasing and energy arbitrage and costs of investment, operation and maintenance, and losses;

$${P}_{ω , t}^{e a}$$

is a profit of TMCS when performing energy arbitrage; C^{IOM} is investment and operation and maintenance costs of TMCSs;

$${Ω}_{J}^{L} , {Ω}_{J}^{s p} and {Ω}_{J}^{lp}$$

are a set of TMCSs and subsets for short-term leasing and long-term leasing, and ∪ represents union operation; t and T are a leasing period and a planning horizon; ω and W^{tmc} are an index and a total number of TMCSs;

$${v}_{ω , t}^{s p} , {v}_{ω , t}^{l , p} and {v}_{ω , t}^{e a}$$

are binary variables, which are 1 if TMCS ω is in short-term leasing, long-term leasing, or grid energy arbitrage state at a time t, and otherwise 0;

$${λ}_{j}^{sp} and {λ}_{j}^{lp}$$

are package prices of short-term leasing and long-term leasing;

$${c}_{ω}^{b t} , {c}_{ω}^{b , f} , {c}_{ω}^{p l} , {c}_{ω}^{t k} , {c}^{dp} , {c}_{ω}^{m t}$$

are an energy storage battery cost, a replacement energy storage battery cost, charger and converter costs, truck and container and other accessory costs, a warehouse cost, and an operation and maintenance cost of TMCS ω; η^{s}, η^{b}, η^{b,f} and η^{mt} are discount coefficients for the TMCS system, energy storage battery, and maintenance costs; K^{b} and K^{s} are service life of energy storage battery and TMCS system;

$${r}_{0}^{T}$$

is a discount rate converted to the planning horizon; and r^{c}, N^{rc} are a replacement serial number and a total number of replacement times of the energy storage battery; and
where the first term in Equation (2a) is a total revenue of TMCO, and the second term is the discounted value of investment and operation and maintenance costs; and items 1-3 in (2c) are discounted values of charger, converter, truck and container component costs, battery investment and replacement costs, and maintenance costs.

A set of

$$S = \{ ( ω , t ) ∈ {Ω}_{J}^{sp} \times T \vert {v}_{ω , t}^{e a} = 1 \}$$

is defined as all pairs (ω, t) that satisfy the condition, where

$${Ω}_{J}^{sp} \times T$$

represents a Cartesian product of ω and t, i.e., all possible (ω, t) combinations.

Operational constraints of the TMCO model are:

$${v}_{ω , t}^{sp} + {v}_{ω , t}^{e a} \leq 1 , ∀ ω ∈ {Ω}_{J}^{sp} , t ∈ T \qquad ( 3 i )$$

$${\sum }_{ω ∈ {Ω}_{J}^{sp}} {v}_{ω , t}^{sp} + {\sum }_{ω ∈ {Ω}_{J}^{lp}} {v}_{ω , t}^{lp} \leq {W}^{t m c} \leq {W}_{max}^{t m c} , ∀ t ∈ T \qquad ( 3 b )$$

$${P}_{ω , t}^{e a} \leq {λ}_{j}^{lp} \leq {λ}_{j}^{sp} \leq {λ}_{j}^{max} \qquad ( 3 c )$$

$${λ}_{j}^{max} = {η}_{j} {c}_{ω , j}^{H} \qquad ( 3 d )$$

$${P}_{ω , t}^{e a} = {\sum }_{ω ∈ {Ω}_{J}^{sp}} {\sum }_{th ∈ H} {λ}_{n}^{th} ( {P}_{dch , ω n}^{t h} - {P}_{ch , ω n}^{t h} ) - {\sum }_{ω ∈ {Ω}_{J}^{sp}} ( {λ}_{{n}_{e}}^{t {h}_{e}} {c}_{e}^{t m c} {D}_{ω}^{e} + {c}_{ω}^{l a} ) - {{c}^{MDC} ( 1 + {r}_{0} )}^{k} \{ {q}_{t h} + {\sum }_{ω ∈ {Ω}_{J}^{sp}} {\sum }_{th ∈ H} ( {P}_{dch , ω n}^{t h} + {P}_{ch , ω n}^{t h} ) \} \qquad ( 3 e )$$

$${\sum }_{n} {ζ}_{ω , n}^{t h} + {\sum }_{n \neq v} {ζ}_{ω , nv}^{t h} = 1 \qquad ( 3 f )$$

$${\sum }_{n \neq v} {ζ}_{ω , nv}^{t h} \geq {ζ}_{ω , n}^{t h + 1} - {ζ}_{ω , n}^{t h} \qquad ( 3 g )$$

$${D}_{ω}^{e} = {v}_{a} {\sum }_{th ∈ H} {\sum }_{n \neq v} {ζ}_{ω , nv}^{t h} \qquad ( 3 h )$$

$${ζ}_{ω , {n}_{e}}^{t {h}_{e}} = 1 \qquad ( 3 i )$$

$$\{ \begin{matrix}0 \leq {P}_{ch , ω n}^{t h} \leq min ( {\sum }_{n} {ζ}_{ω , nv}^{t h} , {l}_{c h , ω}^{t h} ) {P}_{c h , ω}^{max} \\ 0 \leq {P}_{dch , ω n}^{t h} \leq min ( {\sum }_{n} {ζ}_{ω , n}^{t h} , {l}_{dch , ω}^{t h} ) {P}_{dch , ω}^{max}\end{matrix} \qquad ( 3 j )$$

$${I}_{c h , ω}^{t h} + {l}_{dch , ω}^{t h} \leq {\sum }_{n} {ζ}_{ω , n}^{t h} \qquad ( 3 k )$$

$${SOC}_{ω}^{t h + 1} = {SOC}_{ω}^{t h} - \{ {\sum }_{th ∈ H} {P}_{dch , ω n}^{t h + 1} / {η}_{dch , ω} - {η}_{c h , ω} {\sum }_{th ∈ H} {P}_{ch , ω n}^{t h + 1} \} / {E}_{ω}^{t m c} \qquad ( 3 l )$$

$${SOC}_{min} \leq {SOC}_{ω}^{t h} \leq {SOC}_{max} \qquad ( 3 m )$$

where th and H are a dispatching time and a dispatching cycle;

$${W}_{max}^{t m c}$$

is the maximum configuration quantity of TMCS determined by a budget of TMCO;

$${λ}_{j}^{max}$$

is a price ceiling determined by a self-owned cost and a leasing preference of CFO j;

$${c}_{ω , j}^{H}$$

is a self-owned amortization cost converted to the dispatching cycle; ηⱼ is an adjustment coefficient;

$${λ}_{{n}_{e}}^{t {h}_{e}}$$

is an electricity price per kilowatt-hour when TMCS returns to a warehouse for recharging;

$${λ}_{n}^{t h}$$

is a node electricity price for TMCS to participate in a day-ahead electricity energy market for energy arbitrage; n and v are operating locations of TMCS, i.e., energy arbitrage nodes that interact with the power grid;

$${P}_{ch , ω}^{t h} and {P}_{dch , ω n}^{t h}$$

are charging and discharging power of TMCS ω at a time th for a node n;

$${ζ}_{ω , n}^{t h} and {ζ}_{ω , v}^{t h}$$

are binary variables, which are 1 if ω is at a node n or moving on a path (n, v) at a time th, otherwise 0; thₑ and nₑ are a service end time of TMCS and a corresponding garage;

$${D}_{ω}^{e}$$

is a total travel distance in a dispatching period; vₐ is an average driving speed of TMCS;

$${c}_{e}^{t m c}$$

is an energy consumption per kilometer of TMCS;

$${c}_{ω}^{l a}$$

is a labor cost of TMCS ω; c^{MDC} is a marginal aging cost of a TMCS life cycle; qₜₕ is a calendar aging parameter of a TMCS battery pack; k is an annual serial number corresponding to commissioning of TMCS;

$${P}_{c h , ω}^{max} and {P}_{dch , ω}^{max}$$

are the maximum charging and discharging power;

$${I}_{ch , ω}^{th} and {I}_{dch , ω}^{th}$$

are Boolean variables, which are 1 if ω is charged or discharged at a time th, otherwise 0; η_{ch,ω} and η_{dch,ω} are charging and discharging efficiencies of TMCS;

$${E}_{ω}^{tmc}$$

is a capacity of TMCS ω;

$${SOC}_{ω}^{th}$$

is a SOC value of TMCS ω at the dispatching time th; and SOCₘₐₓ and SOCₘᵢₙ are the maximum and minimum SOC values of TMCS.

Equation (3a) is a spatial-temporal operation constraint of TMCS between short-term leasing and arbitrage. Equation (3b) is a leasing quantity constraint. Equations (3c)-(3d) are price constraints. Equations (3f)-(3g) are TMCS transfer constraints. Equations (3j)-(3k) define charging and discharging constraints related to the arbitrage mode. Equations (3l) and (3m) define SOC constraints.

In this case, the EV charging demand, as a typical exogenous variable, has a significant impact on the leasing decision and scheduling arrangement of the CFO. Since the historical charging load data can provide certain probability information, the present disclosure adopts the DRCC method to make a decision under the condition of considering the worst uncertainty probability distribution, thereby effectively avoiding the decision risk, and ensuring the charging service quality of the CFO. The introduction of opportunity constraint helps to reduce the influence of extreme factors on profitability of CFO, thereby realizing the trade-off between decision-making risk and economy of CFO.

An optimization objective of the CFO two-stage DRCC model is to maximize utility, and an expression of the CFO two-stage DRCC model is as follows:

$$\{ \begin{matrix}{y}^{max} {{P}_{m}^{th} ∈ Δ}^{min} {d}^{max} {P}_{j} = {\sum }_{t ∈ T} ( {I}_{ω , t}^{ch} - {C}_{ω , t}^{L} - {C}_{ω , t}^{OM} ) \\ y = [ {v}_{ω , t}^{sp} , {v}_{ω , t}^{lp} ] \\ d = [ {P}_{dch , ω , m}^{th} , {P}_{ch , ω , m}^{th} , {ζ}_{ω , m}^{th} , {ζ}_{ω , n}^{th} , {ζ}_{ω , mu}^{th} , {ζ}_{ω , mn}^{th} , {I}_{ch , ω}^{th} ] \\ ω ∈ {Ω}_{j , t}^{c} = \{ {Ω}_{j , t}^{sp} ⋃ {Ω}_{j}^{lp} \}\end{matrix} \qquad ( 4 a )$$

$${I}_{ω , t}^{ch} = {\sum }_{ω ∈ {Ω}_{j , t}^{c}} {\sum }_{th ∈ H} {λ}_{m}^{ch} {P}_{dch , ω m}^{th} \qquad ( 4 b )$$

$${C}_{ω , t}^{L} = {\sum }_{ω ∈ {Ω}_{j , t}^{sp}} {v}_{ω , t}^{sp} {λ}_{j}^{sp} + {\sum }_{ω ∈ {Ω}_{j , t}^{lp}} {v}_{ω , t}^{lp} {λ}_{j}^{lp} \qquad ( 4 c )$$

$${C}_{ω , t}^{OM} = {\sum }_{ω ∈ {Ω}_{j , t}^{c}} \{ {λ}_{{n}_{e}}^{{th}_{e}} {c}_{e}^{tmc} {D}_{ω}^{c} + {c}_{ω}^{la} + {\sum }_{th ∈ H} {λ}_{n}^{th} {P}_{ch , ω n}^{th} \} + {{c}^{MDC} ( 1 + {r}_{0} )}^{k} \{ {q}_{th} + {\sum }_{ω ∈ {Ω}_{j , t}^{c}} {\sum }_{th ∈ H} ( {P}_{dch , ω m}^{th} + {P}_{ch , ω n}^{th} ) \} \qquad ( 4 d )$$

where Pⱼ is a utility function of CFO j, defined as maximizing the profit of operator while ensuring charging service quality requirements;

$${Ω}_{j , t}^{c} , {Ω}_{j , t}^{sp} and {Ω}_{j}^{lp}$$

are a TMCS set of CFO j, along with its subsets for short-term leasing and long-term leasing;

$${P}_{m}^{th}$$

is an EV charging demand at a node m when selecting TMCS for charging; Δ is an ambiguity set of charging demand; y and d are optimization variables;

$${I}_{ω , t}^{ch}$$

is EV charging service revenue;

$${C}_{ω , t}^{L}$$

is a TMCS leasing cost;

$${C}_{ω , t}^{OM}$$

is a TMCS operating cost;

$${λ}_{m}^{ch}$$

is an EV charging electricity fee;

$${P}_{ch , ω n}^{th} and {P}_{dch , ω n}^{th}$$

are charging and discharging power of TMCS ω at the time th between nodes n and m; m and u are corresponding road network EV charging service nodes; and

$${D}_{ω}^{c}$$

is a TMCS travel distance calculated via the shortest-path method.

Equation (4a) represents a revenue from TMCSs providing EV charging services minus leasing and operating costs thereof.

Constraints of the CFO two-stage DRCC model are:

$${v}_{ω , t}^{sp} + {v}_{ω , t}^{lp} \leq 1 , ∀ ω ∈ {Ω}_{j , t}^{c} , t ∈ T \qquad ( 5 a )$$

$${v}_{ω , t}^{lp} \leq {v}_{ω , τ}^{lp} , ∀ ω ∈ {Ω}_{j , t}^{c} , t ∈ T , τ ∈ T \qquad ( 5 b )$$

$${v}_{ω , t}^{sp} \geq {v}_{ω , τ}^{sp} , ∀ ω ∈ {Ω}_{j , t}^{c} , t ∈ T , τ ∈ T \qquad ( 5 c )$$

$${W}_{j , t}^{c} = {\sum }_{ω ∈ {Ω}_{j , t}^{c}} ( {v}_{ω , t}^{sp} + {v}_{ω , t}^{lp} ) \qquad ( 5 d )$$

$$⌈ {th ∈ t}^{max} \{ {P}_{m}^{th} / {P}_{cs , ω}^{max} - {γ}_{j}^{c} \} ⌉ \leq {W}_{j , t}^{c} \leq {W}^{tmc} \qquad ( 5 e )$$

$${\sum }_{m} {ζ}_{ω , n}^{th} + {\sum }_{n} {ζ}_{ω , n}^{th} + {\sum }_{m \neq u} {ζ}_{ω , mu}^{th} + {\sum }_{m \neq n} {ζ}_{ω , mn}^{th} = 1 \qquad ( 5 f )$$

$${\sum }_{m \neq u} {ζ}_{ω , mu}^{th} + {\sum }_{m \neq n} {ζ}_{ω , m n}^{t} \geq {ζ}_{ω , m}^{th + 1} - {ζ}_{ω , m}^{th} \qquad ( 5 g )$$

$${\sum }_{m \neq u} {ζ}_{ω , mn}^{th} \geq {ζ}_{ω , n}^{th + 1} - {ζ}_{ω , n}^{th} \qquad ( 5 h )$$

$${D}_{ω}^{c} = {v}_{α} {\sum }_{t h ∈ H} ( {\sum }_{m \neq u} {ζ}_{ω , mu}^{th} + {\sum }_{m \neq n} {ζ}_{ω , mu}^{th} ) \qquad ( 5 i )$$

$${ζ}_{ω , {n}_{e}}^{{th}_{e}} = 1 \qquad ( 5 j )$$

$$0 \leq {P}_{ch , ω n}^{th} \leq min ( {\sum }_{n} {ζ}_{ω , n}^{th} , {I}_{ch , ω}^{th} ) {P}_{ch , ω}^{max} \qquad ( 5 k )$$

$${P}_{dch , ω m}^{th} \leq {ζ}_{ω , m}^{th} {P}_{cs , ω}^{max} \qquad ( 5 l )$$

$${\sum }_{ω} {P}_{dch , ω m}^{th} \geq max ( {P}_{m}^{th} - {γ}_{j}^{c} {P}_{cs , ω}^{max} , 0 ) \qquad ( 5 m )$$

$${I}_{ch , ω}^{th} \leq {\sum }_{n} {ζ}_{ω , n}^{th} \qquad ( 5 n )$$

$${SOC}_{ω}^{th + 1} = {SOC}_{ω}^{th} - \{ {\sum }_{t h ∈ H} {P}_{dch , ω n}^{th + 1} / {η}_{dch , ω} - {η}_{ch , ω} {\sum }_{t h ∈ H} {P}_{dch , ω m}^{th + 1} \} / {E}_{ω}^{tmc} \qquad ( 5 o )$$

$${SOC}_{min} \leq {SOC}_{ω}^{th} \leq {SOC}_{max} where \qquad ( 5 p )$$

$${W}_{j , t}^{c}$$

is a total number of leased units of CFO j at t;

$${P}_{cs , ω}^{max}$$

is the maximum output power of TMCS ω when providing EV charging service, and determined by the number of charging piles and rated power of TMCS;

$${γ}_{j}^{c}$$

is an EV charging demand response ratio of CFO j, which reflects charging service quality preference of CFO;

$${ζ}_{ω , mu}^{th} and {ζ}_{ω , mn}^{th}$$

are binary variables, if ω is moving on a path (m, u) or (m, n) at the time th,

$${ζ}_{ω , mu}^{th} = 1 or {ζ}_{ω , mn}^{th} = 1 ,$$

otherwise the two are 0.

Equations (5a)-(5c) are spatial-temporal operation constraints for leasing. Equations (5d)-(5e) are leasing quantity constraints. Equations (5f)-(5h) are TMCS charging service and transfer constraints. Equations (5k)-(5m) are TMCS power and charging service quality constraints.

The outer-layer maximization objective represents the first-stage optimization problem: identifying the leasing solution that maximizes the objective function. The middle layer minimization and inner layer maximization represent the two-stage optimization problem: the middle-layer min identifies the worst scenario within the uncertain set of charging demands under a given leasing solution. The inner-layer max adjusts the operational variables (movement and charging strategies of each TMCS) under the worst-case scenario to ensure the leasing solution satisfies all constraints while maximizing the objective function.

In this case, in S2, a Wasserstein distance distribution robust model based on chance constraint is introduced through the distributed robust optimization strategy; this robust model achieves a balance between the economic efficiency and robustness of the bi-level game model.

Specifically, although the accurate probability distribution of

$${P}_{m}^{th}$$

is not available, historical data can still provide probabilistic insights that facilitate the configuration of the ambiguity set. An ambiguity set is a collection of distributions at a statistical distance from a reference distribution. It provides a margin for variation in scenario probability distributions. This approach seeks to balance the economic feasibility and model robustness by constructing ambiguity sets using distance metrics. E.g., 1-norm, ∞-norm, χ2 distance, and Wasserstein distance, aiming to better balance the economy and robustness of the model.

Assuming that there is a historical dataset {\hat{β}⁽¹⁾, \hat{β}⁽²⁾, . . . \hat{β}^{(N)}}, the empirical distribution [symbol] is constructed using Dirac function as an estimate of the true distribution:

$${\hat{ℙ}}_{N} = {\sum }_{l = 1}^{N} {δ}_{{\hat{β}}^{( l )}} / N \qquad ( 6 )$$

where N is the number of sample groups; and δ_{\hat{β}}_{^{(l)}} is the unit point mass at a step response at \hat{β}^{(l)}.

When N→∞, [symbol] converges to [symbol] , i.e., as more data becomes available, the “distance” between [symbol] and [symbol] decreases.

One method to establish the “distance” for the convergence of [symbol] to [symbol] is to use the Wasserstein distance, which is defined as follows:

$$W ( {ℙ}_{1} , {ℙ}_{2} ) = inf \{ \int {Ξ}^{2} ‖ {\tilde{ξ}}_{1} - {\tilde{ξ}}_{2} ‖ \prod ( d {\tilde{ξ}}_{1} , d {\tilde{ξ}}_{2} ) \} \qquad ( 7 )$$

where W(⋅) represents the Wasserstein distance; Π is the joint distribution of random variables ξ₁ and ξ₂, with marginal distributions [symbol] and [symbol] ; Ξ² is a support set of random variables; and ∥⋅∥₁ represents the norm, typically taken as the 1-norm.

Thus, there is W( [symbol] , [symbol] )≤ε(N), where ε(⋅) is a monotonic function related to the sample size, decreasing to 0 as N approaches infinity. Therefore, given a historical dataset with N samples, the true distribution [symbol] belongs to the following ambiguity set:

$${ℙ}_{N} = \{ ℙ ∈ ℙ ( Ξ ) : W ( ℙ , {\hat{ℙ}}_{N} ) \leq ε ( N ) \} \qquad ( 8 )$$

where [symbol] is a Wasserstein ball centered at the empirical distribution [symbol] with a radius of ε(N); and [symbol] (Ξ) denotes the space of all values supported by [symbol] .

The radius ε is related to the sample size (N) and confidence level (1−ρ_{ε}):

$$ε ( N ) = {D}_{ε} \sqrt{ln ( 1 / ( 1 - {ρ}_{ε} ) ) / N} \qquad ( 9 )$$

where D_{ε} is an auxiliary variable;

$${D}_{ε} = \begin{matrix}inf \\ α > 0\end{matrix} \sqrt{2 ( 1 + ln ( {\sum }_{l = 1}^{B} {e}^{α {‖ {\hat{β}}^{( l )} - \hat{μ} ‖}_{1}^{2}} / N ) ) / α} \qquad ( 10 )$$

where \hat{μ} is a sample mean; α is an auxiliary variable; and ρ_{ε} represents confidence level of ambiguity set.

The auxiliary variable α is obtained by solving equation (10) through the bisection search method, which in turn determines D_{ε} and substitutes it into equation (9) to obtain the radius ε. Subsequently, constraint (5m) is reformulated into the DRCC form.

$${ℙ}_{ev} \{ {P}_{m}^{th} - {γ}_{j}^{c} {P}_{cs , ω}^{max} - {\sum }_{ω} {P}_{dch , ω m}^{th} \leq 0 \} \geq 1 - {ρ}_{ev} , ∀ {ℙ}_{ev} ∈ ℙ ( Ξ ) \qquad ( 11 )$$

where [symbol] is a possible distribution in the ambiguity set; and 1−ρₑᵥ represents the confidence level of the chance constraint.

To keep generality, this expression is further expressed in compact form:

$$\begin{matrix}inf & E \\ {ℙ}_{ev} ∈ ℙ ( Ξ ) & \hat{β}\end{matrix} \{ {α ( d )}^{T} \cdot \hat{β} - b ( d ) \leq 0 \} \geq 1 - {ρ}_{ev} \qquad ( 12 )$$

where E(⋅) represents the expected calculation; and a and b are coefficient vectors.

However, such probabilistic nonlinear constraints are difficult to solve directly. By introducing auxiliary variables φ₁, φ₂ and sₗ, the approximate value of CVaR of the above probability constraints is derived:

$$\{ \begin{matrix}{φ}_{1} \cdot ε - {φ}_{2} \cdot {ρ}_{ev} \leq {\sum }_{l = 1}^{N} {s}_{l} / N \\ {s}_{l} + {φ}_{2} \leq max \{ b ( d ) - a ( d ) {\hat{β}}^{( l )} \} \\ {‖ a ( d ) ‖}_{∞} \leq φ \\ {φ}_{1} > 0 , {φ}_{2} \geq 0 , {s}_{l} \leq 0 , ∀ l \leq N\end{matrix} . \qquad ( 13 )$$

The above process shows that CVaR approximation transforms opportunity constraints into a set of manageable linear constraints.

In this example, in S3, the TMCO model is solved through a GA to obtain a revenue-maximizing configuration and a leasing price; and the CFO two-stage DRCC model is solved via an NC&CG algorithm to obtain a leasing plan and a scheduling strategy with maximum utility.

Specifically, the bi-level game model belongs to a BLO problem, and the objective function and constraints are linear. The model includes continuous variables and integer variables, belonging to a mixed-integer linear programming (MILP) problem. Moreover, a two-stage DRO problem in the model is difficult to solve by a unified optimization method. To handle such optimization problems, a combination of multiple algorithms is usually used for solution. Therefore, the present disclosure uses a hybrid method combining the GA and NC&CG for model solving.

The upper layer problem is determined by the TMCO to determine the configuration number of TMCS and the leasing price, and the GA has good robustness in searching for the global approximate optimal solution.

The lower layer problem is solved by NC&CG, including inner and outer double layer column-and-constraint generation (CCG) cycles. The proposed method is similar to the traditional Benders decomposition method, and the original problem is decomposed into the MP and the SP for alternating iterative solution. Since the iterative process continuously adds variables and constraints related to SP to the MP, C&CG can obtain a more compact lower bound of the original objective function value, thus effectively reducing the number of iterations. For ease of explanation, the CFO model in the previous section is rewritten into the following compact form:

$$\{ \begin{matrix}\begin{matrix}max min max \\ y ∈ Y β ∈ Δ d ( {d}_{1} , {d}_{2} ) ∈ D ( y , β )\end{matrix} ( {F}^{T} y + {G}^{T} d ) \\ {L}_{1} y \leq {ℚ}_{1} , {L}_{2} y + {J}_{1} β \leq {ℚ}_{2} , {S}_{1} {d}_{1} + {L}_{3} y = {ℚ}_{3} \\ s . t . {S}_{2} {d}_{1} + {L}_{4} y \leq {ℚ}_{4} , {V}_{1} {d}_{2} + {S}_{3} {d}_{1} + {L}_{5} y \leq {ℚ}_{5} \\ {V}_{2} {d}_{2} + {L}_{6} y + {J}_{2} β \leq {ℚ}_{6} , {V}_{3} {d}_{2} + {L}_{7} y = {ℚ}_{7}\end{matrix} \qquad ( 14 )$$

where F^{T} and G^{T} are constant coefficient matrices; y and d₁ are 0-1 decision variables for the first stage and the second stage of the above problem; d₂ is a continuous decision variable for the second stage optimization; β is an uncertain parameter of EV charging demand; F, G, L₁-L₇, J₁-J₂, S₁-S₃, V₁-V₃ are corresponding coefficient matrices; and Q₁-Q₇ are constant column vectors.

The first constraint in Equation (14) represents Equations (5a)-(5c) of the original problem; the second constraint in Equation (14) represents Equations (5d)-(5e) of the original problem; the third constraint in Equation (14) represents Equations (5f), (5i)-(5j) of the original problem; the fourth constraint in Equation (14) represents Equations (5g)-(5h), (5n) of the original problem; the fifth constraint in Equation (14) represents Equations (5k), (5l) of the original problem; the sixth constraint in Equation (14) represents Equation (5m) of the original problem; and the seventh constraint in Equation (14) represents Equation (5o) of the original problem.

Equation (14) is decomposed to obtain the following MP and SP:
an expression of the MP is as follows:

$$MP \{ \begin{matrix}\begin{matrix}max \\ y\end{matrix} ( {F}^{T} y + {x}_{1} ) \\ {x}_{1} \leq {G}^{T} {d}^{{S}_{1}} , {L}_{1} y \leq {ℚ}_{1} \\ {L}_{2} y + {J}_{1} {{β}^{{S}_{1}}}^{*} \leq {ℚ}_{2} , {S}_{1} {d}_{1}^{{S}_{1}} + {L}_{3} y = {ℚ}_{3} \\ s . t . {S}_{2} {d}_{1}^{{S}_{1}} + {L}_{4} y \leq {ℚ}_{4} , {V}_{1} {d}_{2}^{{S}_{1}} + {S}_{3} {d}_{1}^{{S}_{1}} + {L}_{5} y \leq {ℚ}_{5} \\ {V}_{2} {d}_{2}^{{S}_{1}} + {L}_{6} y + {J}_{2} {{β}^{{S}_{1}}}^{*} \leq {ℚ}_{6} \\ {V}_{3} {d}_{2}^{{S}_{1}} + {L}_{7} y = {ℚ}_{7} , ∀ {s}_{1} \leq {s}_{2}\end{matrix} \qquad ( 15 )$$

where * represents a known quantity; s₁ and s₂ are the historical and current iteration numbers of the outer loop; x₁ is an auxiliary variable, representing the optimal value of the objective function in the second stage.

An expression of the SP is as follows:

$$SP \{ \begin{matrix}\begin{matrix}min & max \\ β & {d}_{1} , {d}_{2}\end{matrix} ( {F}^{T} {y}^{*} + {G}^{T} d ) \\ {L}_{2} {y}^{*} + {J}_{1} β \leq {ℚ}_{2} \\ {S}_{1} {d}_{1} + {L}_{3} {y}^{*} = {ℚ}_{3} \\ {S}_{2} {d}_{1} + {L}_{4} {y}^{*} \leq {ℚ}_{4} \\ s . t . {V}_{1} {d}_{2} + {S}_{3} {d}_{1} + {L}_{5} {y}^{*} \leq {ℚ}_{5} \to {τ}_{1} \geq 0 \\ {V}_{2} {d}_{2} + {L}_{6} {y}^{*} + {J}_{2} β \leq {ℚ}_{6} \to {τ}_{2} \geq 0 \\ {V}_{3} {d}_{2} + {L}_{7} {y}^{*} = {ℚ}_{7} \to {τ}_{3}\end{matrix} \qquad ( 16 )$$

where τ₁, τ₂ and τ₃ are dual variables corresponding to each constraint.

The outer layer C&CG algorithm is used to iteratively solve the MP, and the upper bound Uₒᵤₜ is determined by combining the scenario variable fl. The first stage decision variable y is substituted into the SP for solution, and the lower bound Lₒᵤₜ of the original problem is obtained. The feedback from the SP is used to update the MP, and new constraints and variables are iteratively introduced until the convergence condition described in (17) is satisfied, and the optimal solution is obtained.

$$\vert {U}_{out} - {L}_{out} \vert / {L}_{out} \leq ψ \qquad ( 17 )$$

where ψ is an extremely small positive real number, representing a convergence gap.

SP is a bi-level MILP problem with Boolean variables, including a binary variable d₁ that does not satisfy Karush-Kuhn-Tucker (KKT) conditions. Therefore, SP is decomposed into an MPS and an SPS.

An expression of the MPS is as follows:

$$MPS \{ \begin{matrix}\begin{matrix}min \\ β\end{matrix} ( {F}^{T} {y}^{*} + {x}_{2} ) \\ {x}_{2} \geq {G}^{T} {d}_{2}^{{r}_{1}} \\ {L}_{2} {y}^{*} + {J}_{1} β \leq {ℚ}_{2} , {S}_{1} {d}_{1}^{{r}_{1}^{*}} + {L}_{3} {y}^{*} = {ℚ}_{3} \\ {S}_{2} {d}_{1}^{{r}_{1}^{*}} + {L}_{4} {y}^{*} \leq {ℚ}_{4} , {V}_{1} {d}_{2}^{{r}_{1}} + {S}_{3} {d}_{1}^{{r}_{1}^{*}} + {L}_{5} {y}^{*} \leq {ℚ}_{5} \\ {V}_{2} {d}_{2}^{{r}_{1}} + {L}_{6} {y}^{*} + {J}_{2} β \leq {ℚ}_{6} , {V}_{3} {d}_{2}^{{r}_{1}} + {L}_{7} {y}^{*} = {ℚ}_{7} \\ s . t . 0 \leq {τ}_{1}^{{r}_{1}} \leq {MI}_{1}^{{r}_{1}} , {V}_{1} {d}_{2}^{{r}_{1}} + {S}_{3} {d}_{1}^{{r}_{1}^{*}} + {L}_{5} {y}^{*} - {ℚ}_{5} \leq M ( 1 - {I}_{1}^{{r}_{1}} ) \\ 0 \leq {τ}_{2}^{{r}_{1}} \leq {MI}_{2}^{{r}_{1}} , {V}_{2} {d}_{2}^{{r}_{1}} + {L}_{6} {y}^{*} + {J}_{2} β - {ℚ}_{6} \leq M ( 1 - {I}_{2}^{{r}_{1}} ) \\ {ℒ}^{{r}_{1}} = G - {V}_{1}^{T} {τ}_{1}^{{r}_{1}} - {V}_{2}^{T} {τ}_{2}^{{r}_{1}} - {V}_{3}^{T} {τ}_{3}^{{r}_{1}} \\ 0 \leq {d}_{2}^{{r}_{1}} \leq {MI}_{0}^{{r}_{1}} , 0 \leq {ℒ}^{{r}_{1}} \leq M ( 1 - {I}_{0}^{{r}_{1}} ) , ∀ {r}_{1} \leq {r}_{2}\end{matrix} \qquad ( 18 )$$

where r₁ and r₂ are the historical and current iteration numbers of the inner loop; x₂ is an auxiliary variable representing the optimal value of the inner layer objective function; M is an extremely large positive real number;

$${I}_{0}^{{r}_{1}} , {I}_{1}^{{r}_{1}} and {I}_{2}^{{r}_{1}}$$

are 0-1 variables introduced in a linearization process of KKT complementary slackness conditions.

An expression of the SPS is as follows:

$$S P S \{ \begin{matrix}\begin{matrix}min \\ {d}_{1} , {d}_{2}\end{matrix} ( {F}^{T} {y}^{*} + {G}^{T} d ) \\ {S}_{1} {d}_{1} + {L}_{3} {y}^{*} = {ℚ}_{3} \\ {S}_{2} {d}_{1} + {L}_{4} {y}^{*} = {ℚ}_{4} \\ s . t . {V}_{1} {d}_{2} + {S}_{3} {d}_{1} + {L}_{5} {y}^{*} \leq {ℚ}_{5} \\ {V}_{2} {d}_{2} + {L}_{6} {y}^{*} + {J}_{2} {β}^{*} \leq {ℚ}_{6} \\ {V}_{3} {d}_{2} + {L}_{7} {y}^{*} = {ℚ}_{7}\end{matrix} \qquad ( 19 )$$

where β* is a realization value of uncertainty.

MPS reformulates the inner-layer maximization problem into a single-layer minimization problem, generates Lᵢₙ, and uses β obtained from MPS to calculate Uᵢₙ in SPS. Iterative updates are performed using d₁ and new constraints until the inner loop converges, as shown in Equation (20), and Lᵢₙ and Lₒᵤₜ are fed back to MP as the final scenario.

$$\vert {U}_{i n} - {L}_{i n} \vert / {L}_{i n} \leq ψ . \qquad ( 20 )$$

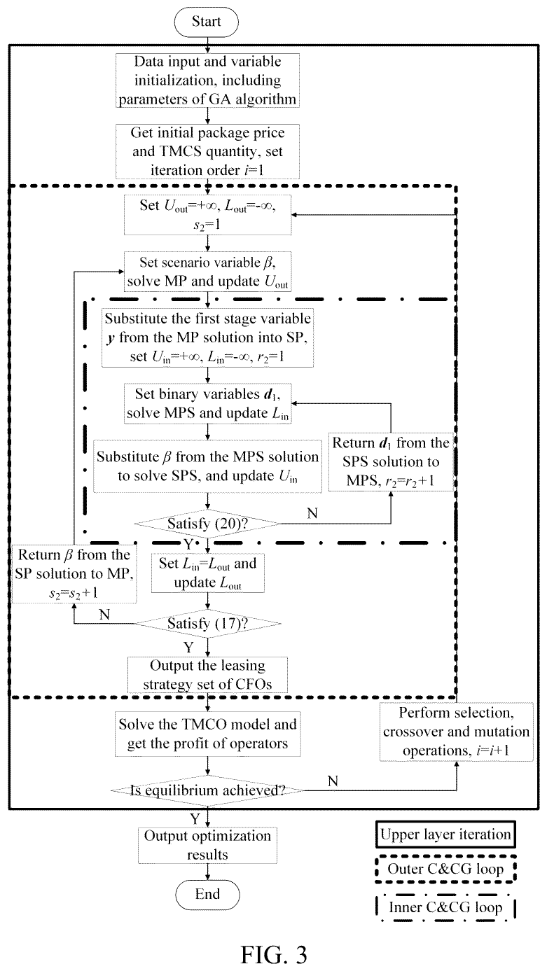

The solution process of the bi-level game model is shown in FIG. 3. When the deviation of the operator utility function (P_{T} and Pⱼ) between the two iterations is less than the convergence gap, the iteration ends and the maximum scheduling strategy is obtained.

In one possible example, specific optimization instances are provided as follows.

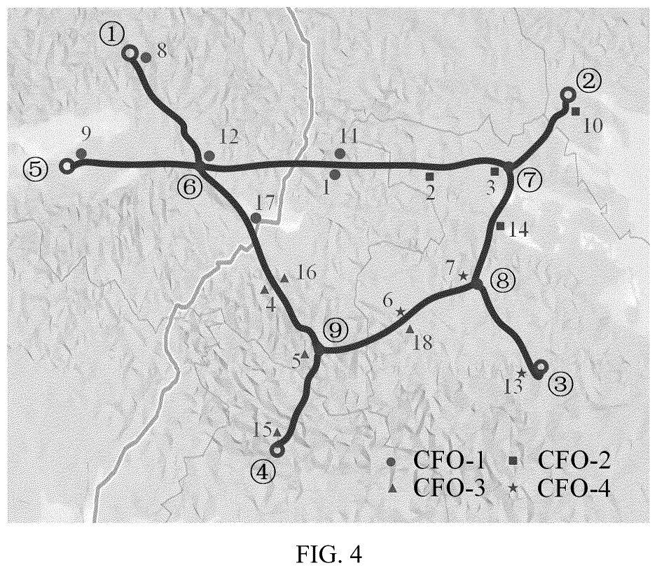

In the instances, the ring-form highway network is shown in FIG. 4. The road network includes five entrances and exits nodes with a total mileage of 465 km. Nodes 1, 2 and 4 serve large cities while nodes 3 and 5 connect to smaller cities. This topology reflects the current practical application of TMCS, mainly serving as a temporary supplement to FCSs along highways. The planning scope is set as Has one day and T as one year. The sample set is based on the traffic flow statistics of the road network in the Pearl River Delta region of China and the holiday schedule in 2023. The schedule divides the year into three typical days: weekdays, weekends and holidays. It is assumed that the 18 FCSs along the road network are operated by four independent CFOs, with locations shown in FIG. 4. The grid arbitrage revenue is calculated based on the time-of-use tariff of a certain province in China. The population size of the GA is set to 30, with a maximum iteration of 50, and the mutation and crossover rate are set to 0.2 and 0.6. Other parameters are shown in Table 1.

TABLE 1
Other simulation parameters

| Variable | Value | Unit | Variable | Value | Unit | Variable | Value | Unit |
|---|---|---|---|---|---|---|---|---|
| ${c}_{e}^{t m c}$ | 1.25 | kwh/km | ${c}_{ω}^{b t}$ | 1000 | ¥/kWh | ρ_{ε} | 0.1 | / |
| vₐ | 60 | km/h | ${c}_{ω}^{b t , f}$ | 600 | ¥/kWh | ρₑᵥ | 0.1 | / |
| ${λ}_{j}^{max}$ | 6 | ¥10³/d | ${c}_{ω}^{p l}$ | 10⁵ | ¥/pile | η_{ch,ω} | 0.95 | / |
| K^{b} | 120 | mth | ${c}_{ω}^{l a}$ | 6*10³ | ¥/mth | n_{dch,ω} | 0.95 | / |
| K^{s} | 240 | mth | ${c}_{ω}^{t k}$ | 3.5*10⁵ | ¥ | thₑ | 23 | / |
| c^{MDC} | 315 | ¥/MWh | ${P}_{c h , ω}^{max}$ | 500 | kW | SOCₘₐₓ | 0.95 | / |
| qₜ | 1000 | kWh/d | ${P}_{dch , ω}^{max}$ | 300 | kW | SOCₘᵢₙ | 0.15 | / |
| ${r}_{0}^{T}$ | 6 | % | κ | 1 | / | N^{rc} | 1 | / |

To validate the effectiveness of the present disclosure, the following three cases are considered: Case1 employs the self-owned mode of CFO. Case2 adopts a uniform pricing scheme under the proposed TMCO leasing framework. Case3 implements the method of the present disclosure, that is, a differentiated pricing scheme under the proposed TMCO leasing framework. In addition, the owners of TMCS (CFOs in Case1, TMCO in Case2 and 3) increase revenue during idle periods by participating in grid energy arbitrage when there is no charging demand.

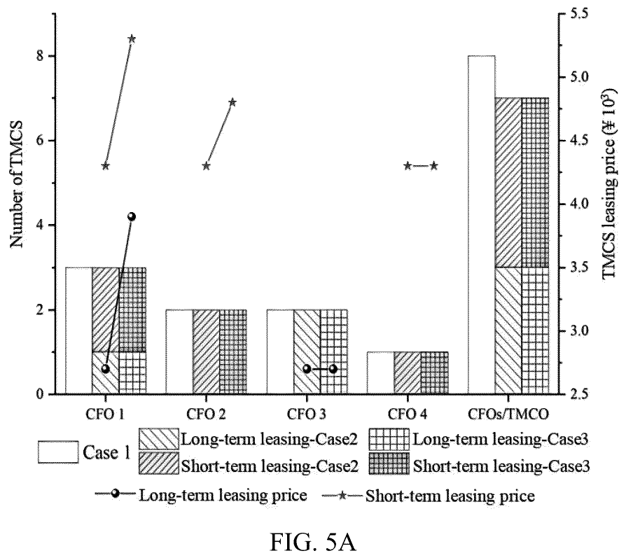

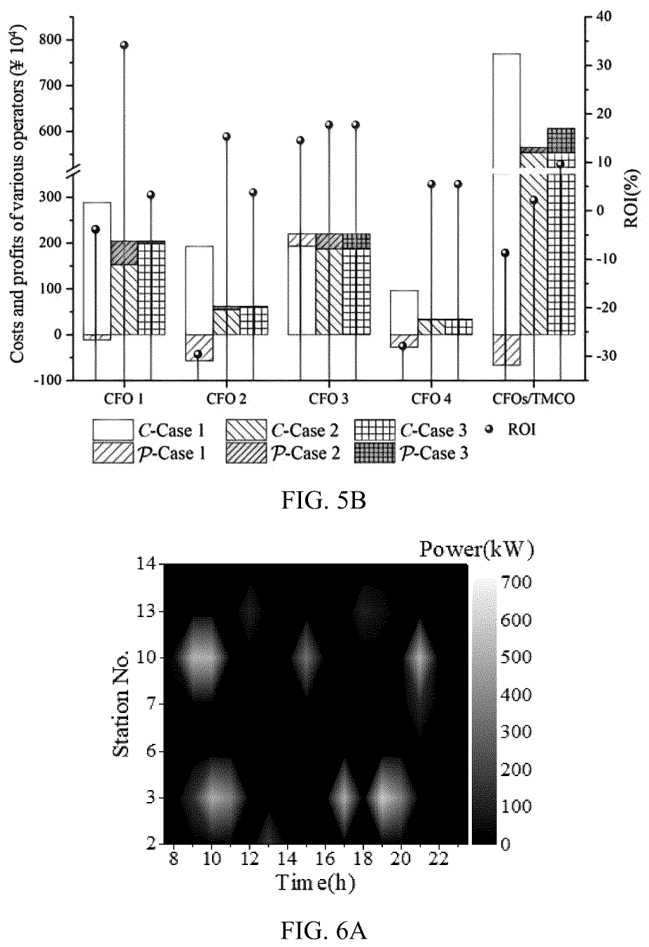

FIGS. 5A and 5B show the operational status and economic indicators of each operator, in which the capacity of each TMCS is 2 MW, the leasing prices are converted values based on the scheduling horizon. C and Π denote the cost and profit of each operator in the planning period. ROI denotes the return on investment of operators, while CFOs represent the total value of each CFO. FIG. 5A reveals that CFO2 and CFO4 both choose short-term leasing, CFO1 also prefer 67% of demand for short-term leasing, and only CFO3 chooses long-term leasing. This indicates that most CFOs primarily require TMCS to meet short-term EV charging demands, resulting in low utilization rates in the planning period. Under current electricity market policies, profits obtained through grid energy arbitrage are limited. Therefore, Case1 demonstrates poor economic viability, with a negative ROI in FIG. 5B, indicating that operators cannot achieve profitability.

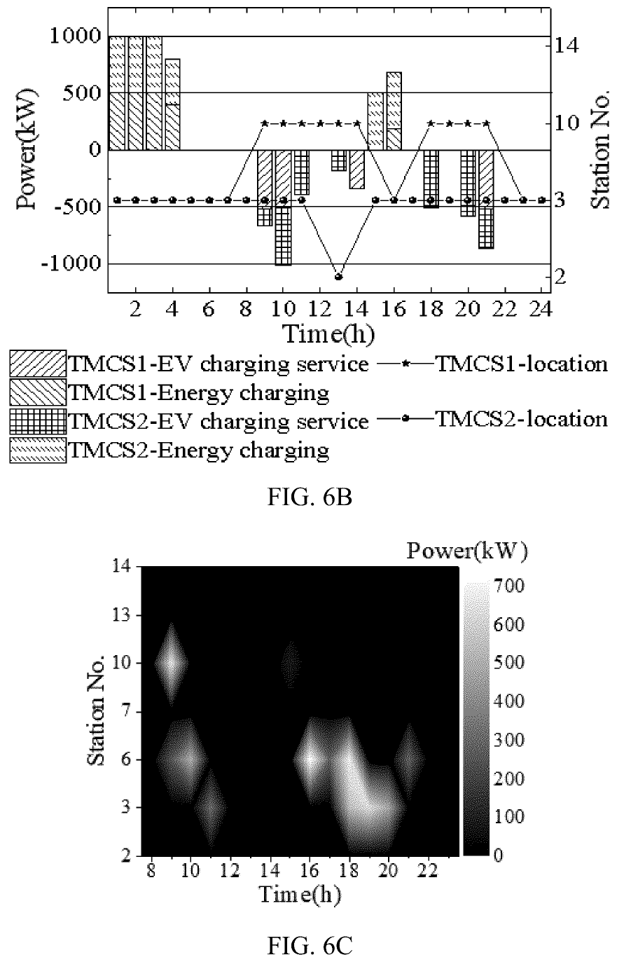

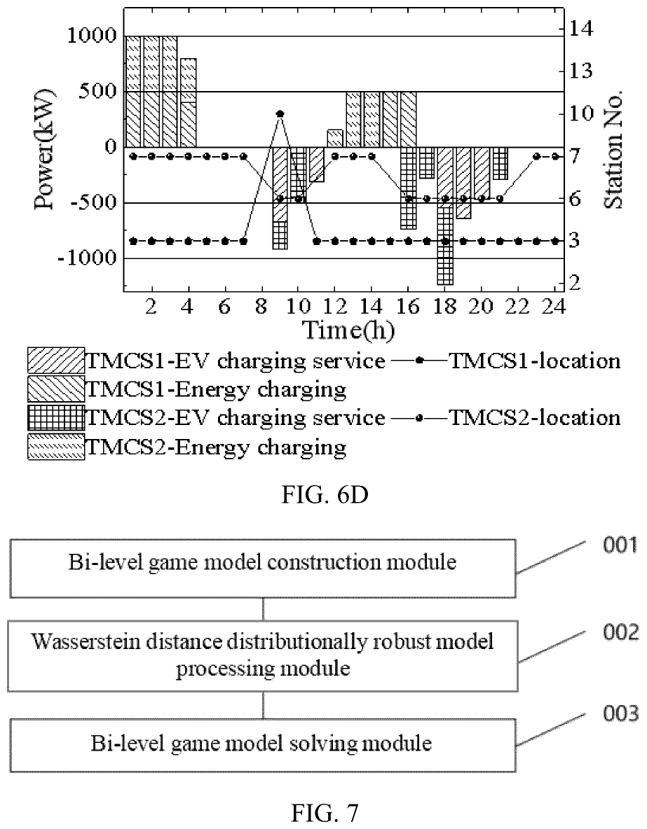

However, in Case 2 and Case 3, the cost of CFO is significantly reduced. Meanwhile, by balancing the demand for differentiated short-term leasing, TMCO optimizes the configuration quantity of TMCS, thereby improving the profitability of TMCO. FIGS. 6A, 6B, 6C and 6D show the charging demand and TMCS operation at selected sites, the positive power in FIG. 6B and FIG. 6D represents TMCS charging, and the negative power represents discharging. It can be seen that CFO2 demands to lease 2 TMCS for short-term use on Typical Day 1 to meet the charging demand, but only 1 TMCS is required on Typical Day 2. In contrast, CFO4 demands to lease 0 and 1 TMCS in these two scenarios to meet its own charging demands. Therefore, TMCO only needs to deploy 2 TMCSs to meet the above requirements. However, in Case 2, the leasing price is restricted by the relatively low leasing demand (with long-term leasing for CFO3 and short-term leasing for CFO4), which results in a lower profit margin for TMCO. In Case 3, TMCO determines the leasing price through a game with each CFO. Since the leasing demand from CFO1 and CFO2 is relatively high, TMCO enhances its profitability by increasing the respective leasing prices thereof.

It is observed that the traditional self-owned operation mode is more suitable for scenarios involving long-term continuous charging and high EV charging demand (such as CFO3), while the leasing business model proposed in the present disclosure is applicable to both long-term and short-term charging loads. Short-term charging demand is more beneficial for CFOs, which not only ensures charging service quality but also makes certain profits. For TMCO, profits mainly comes from long-term leasing, and implementing different price strategies for CFOs helps ensure overall profitability. However, it is crucial to balance the revenue levels across CFOs to prevent market exit due to excessively high pricing. In addition, it is important to note that when the short-term leasing demands of different CFOs are complementary (i.e., occurring at different time periods), TMCO can effectively maximize the utilization of TMCS. This resembles a time-sharing scheduling approach, reducing the required fleet size and associated investment costs. By responding to different short-term leasing demands, the proposed business model enhances the utilization of TMCS and achieves mutual benefits for both CFO and TMCO.

In summary, the present disclosure offers the following advantages. A bi-level game model is constructed based on a TMCS leasing mode; and the bi-level game model includes a TMCO model and a CFO two-stage DRCC model. A Wasserstein distance distributionally robust model based on chance constraints is introduced through a DRO strategy; and economy and robustness of the bi-level game model are balanced via the Wasserstein distance distributionally robust model. The TMCO model is solved through a GA to obtain a revenue-maximizing configuration and a leasing price; and the CFO two-stage DRCC model is solved via an NC&CG algorithm to obtain a leasing plan and a scheduling strategy with maximum utility. In the present disclosure, a BLO method framework based on a TMCS leasing mode is provided. An upper layer aims to maximize the revenue of TMCOs. TMCOs set long-term and short-term leasing packages according to varying leasing demand, balance and determine leasing prices for different participants and the configuration quantity of TMCS, and schedule TMCS to participate in grid energy arbitrage in idle periods. A lower layer, with the objective of maximizing the utility of CFOs, responds to the leasing packages and feeds back the leasing quantity and leasing duration. In the present disclosure, the DRO method is adopted to introduce a Wasserstein DRCC model to fully consider the influence of charging demand prediction error on optimization results. In the present disclosure, based on a CVaR approximation method, the upper and lower layers of the model are solved using the GA and NC&CG algorithm. Through adaptive pricing and resource allocation strategies, the present disclosure can effectively balance the needs of TMCOs and CFOs, ensuring the profitability of TMCOs while improving the economy of CFOs.

It is to be noted that the method of the example of the present disclosure may be executed by a single device, such as a computer or a server. The method of this example can also be applied to a distributed scenario, and is completed by a plurality of devices cooperating with each other. In the case of such a distributed scenario, one of the plurality of devices may perform only one or more steps in the method according to this example of the present disclosure, and the plurality of devices may interact with each other to complete the method.

It is to be noted that some examples of the present disclosure have been described above. Other examples are within the scope of the appended claims. In some cases, the acts or steps recited in the claims may be performed in a different order than in the examples described above and the desired results may still be achieved. Additionally, the processes depicted in the drawings do not necessarily require a particular order or a sequential order shown to achieve the desired results. In some embodiments, multitasking and parallel processing are also possible or may be advantageous.

### Example 2

Referring to FIG. 7, Example 2 of the present disclosure further provides a BLO device based on a TMCS leasing mode, including a bi-level game model construction module 001, a Wasserstein distance distributionally robust model processing module 002, and a bi-level game model solving module 003.

The bi-level game model construction module 001 is configured to construct a bi-level game model based on a TMCS leasing mode, the bi-level game model including a TMCO model and a CFO two-stage DRCC model.

The Wasserstein distance distributionally robust model processing module 002 is configured to introduce a Wasserstein distance distributionally robust model based on chance constraints through a DRO strategy; and balance economy and robustness of the bi-level game model via the Wasserstein distance distributionally robust model.

The bi-level game model solving module 003 is configured to solve the TMCO model through a GA to obtain a revenue-maximizing configuration and a leasing price; and solve the CFO two-stage DRCC model via an NC&CG algorithm to obtain a leasing plan and a scheduling strategy with maximum utility.

In this example, in the bi-level game model construction module 001, an optimization objective of the TMCO model is to maximize the net income; and an expression of the TMCO model is as follows:

$$\{ \begin{matrix}\begin{matrix}max \\ x\end{matrix} {P}_{T} = {\sum }_{t ϵ T} ( {I}_{ω , t}^{L} + {v}_{ω , t}^{e a} {P}_{ω , t}^{e a} ) - {C}^{I O M} \\ x = [ {λ}_{j}^{s p} , {λ}_{j}^{lp} , {W}^{t m c} , {v}_{ω , t}^{e a} ] \\ {ωϵΩ}_{J}^{L} = \{ {Ω}_{J}^{s p} ⋃ {Ω}_{J}^{lp} \}\end{matrix}$$

$${I}_{ω , t}^{L} = {\sum }_{{ωϵΩ}_{J}^{s p}} {v}_{ω , t}^{s p} {λ}_{j}^{s p} + {\sum }_{{ωϵΩ}_{J}^{lp}} {v}_{ω , t}^{lp} {λ}_{j}^{lp}$$

$${C}^{I O M} = {\sum }_{ω} [ {η}^{s} ( {c}_{ω}^{pl} + {c}_{ω}^{t k} ) + {η}^{b} ( {c}_{ω}^{b t} + {η}^{b , f} {c}_{ω}^{b , f} ) + {η}^{m t} {c}_{ω}^{m t} ] + {η}^{s} {c}^{dp}$$

$$\{ \begin{matrix}{η}^{s} = {{r}_{0}^{T} ( 1 + {r}_{0}^{T} )}^{{K}^{s}} / [ {( 1 + {r}_{0}^{T} )}^{{K}^{s}} - 1 ] \\ {η}^{b} = {{r}_{0}^{T} ( 1 + {r}_{0}^{T} )}^{{K}^{b}} / [ {( 1 + {r}_{0}^{T} )}^{{K}^{b}} - 1 ] \\ {η}^{b , f} = {\sum }_{{r}^{c} = 1}^{{N}^{r c}} 1 / {( 1 + {r}_{0}^{T} )}^{{r}^{{c}_{K} b}} \\ {η}^{m t} = 1 / {( 1 + {r}_{0}^{T} )}^{{K}^{s}}\end{matrix}$$

$$where {I}_{ω , t}^{L}$$

is a leasing revenue of TMCSs; P_{T} is a revenue function of TMCO, representing the difference between the total revenue from leasing and energy arbitrage and costs of investment, operation and maintenance, and losses; is a profit of TMCS when performing energy arbitrage; C^{IOM} is investment and operation and maintenance costs of TMCSs;

$${Ω}_{J}^{L} , {Ω}_{J}^{s p} and {Ω}_{J}^{lp}$$

are a set of TMCSs and subsets for short-term leasing and long-term leasing, and ∪ represents union operation; t and T are a leasing period and a planning horizon; ω and W^{tmc} are an index and a total number of TMCSs;

$${v}_{ω , t}^{sp} , {v}_{ω , t}^{lp} and {v}_{ω , t}^{e a}$$

are binary variables, which are 1 if TMCS ω is in short-term leasing, long-term leasing, or grid energy arbitrage state at a time t, and otherwise 0;

$${λ}_{j}^{s p} and {λ}_{j}^{lp}$$

are package prices of short-term leasing and long-term leasing;

$${c}_{ω}^{b t} , {c}_{ω}^{b , f} , {c}_{ω}^{p l} , {c}_{ω}^{t k} , {c}^{dp} , {c}_{ω}^{m t}$$

are an energy storage battery cost, a replacement energy storage battery cost, charger and converter costs, truck and container and other accessory costs, a warehouse cost, and an operation and maintenance cost of TMCS ω; η^{s}, η^{b}, η^{b,f} and η^{mt} are discount coefficients for the TMCS system, energy storage battery, and maintenance costs; K^{b} and K^{s} are service life of energy storage battery and TMCS system;

$${r}_{0}^{T}$$

is a discount rate converted to the planning horizon; and r^{c}, N^{rc} are a replacement serial number and a total number of replacement times of the energy storage battery;

Operational constraints of the TMCO model are as follows:

$${v}_{ω , t}^{s p} + {v}_{ω , t}^{e a} \leq 1 , ∀ ω ∈ {Ω}_{J}^{s p} , t ∈ T$$

$${\sum }_{ω ∈ {Ω}_{J}^{s p}} {v}_{ω , t}^{s p} + {\sum }_{ω ∈ {Ω}_{J}^{l p}} {v}_{ω , t}^{l p} \leq {W}^{t m c} \leq {W}_{max}^{t m c} , ∀ t ∈ T$$

$${P}_{ω , t}^{e a} \leq {λ}_{j}^{l p} \leq {λ}_{j}^{s p} \leq {λ}_{j}^{max}$$

$${λ}_{j}^{max} = {η}_{j} {c}_{ω , j}^{H}$$

$${P}_{ω , t}^{e a} = {\sum }_{ω ∈ {Ω}_{J}^{s p}} {\sum }_{t h ∈ H} {λ}_{n}^{t h} ( {P}_{dch , ω n}^{t h} - {P}_{ch , ω n}^{t h} ) - {\sum }_{ω ∈ {Ω}_{J}^{s p}} ( {λ}_{{n}_{e}}^{t {h}_{e}} {c}_{e}^{t m c} {D}_{ω}^{e} + {c}_{ω}^{l a} ) - {{c}^{M D C} ( 1 + {r}_{0} )}^{k} \{ {q}_{t h} + {\sum }_{ω ∈ {Ω}_{J}^{s p}} {\sum }_{t h ∈ H} ( {P}_{dch , ω n}^{t h} + {P}_{ch , ω n}^{t h} ) \}$$

$${\sum }_{n} {ζ}_{ω , n}^{t h} + {\sum }_{n \neq v} {ζ}_{ω , nv}^{t h} = 1$$

$${\sum }_{n \neq v} {ζ}_{ω , nv}^{t h} \geq {ζ}_{ω , n}^{t h + 1} - {ζ}_{ω , n}^{t h}$$

$${D}_{ω}^{e} = {v}_{a} {\sum }_{t h ∈ H} {\sum }_{n \neq v} {ζ}_{ω , nv}^{t h}$$

$${ζ}_{ω , {n}_{e}}^{t {h}_{e}} = 1$$

$$\{ \begin{matrix}0 \leq {P}_{ch , ω n}^{t h} \leq min ( {\sum }_{n} {ζ}_{ω , nv}^{t h} , {I}_{c h , ω}^{t h} ) {P}_{c h , ω}^{max} \\ 0 \leq {P}_{dch , ω n}^{t h} \leq min ( {\sum }_{n} {ζ}_{ω , n}^{t h} , {I}_{dch , ω}^{t h} ) {P}_{dch , ω}^{max}\end{matrix}$$

$${I}_{c h , ω}^{t h} + {I}_{dch , ω}^{t h} \leq {\sum }_{n} {ζ}_{ω , n}^{t h}$$

$${SOC}_{ω}^{t h + 1} = {SOC}_{ω}^{t h} - \{ {\sum }_{t h ∈ H} {P}_{dch , ω n}^{t h + 1} / {η}_{dch , ω} - {η}_{c h , ω} {\sum }_{t h ∈ H} {P}_{ch , ω n}^{t h + 1} \} / {E}_{ω}^{t m c} \qquad ( 31 )$$

$${SOC}_{min} \leq {SOC}_{ω}^{t h} \leq {SOC}_{max}$$

where th and H are a dispatching time and a dispatching cycle;

$${W}_{max}^{t m c}$$

is the maximum, configuration quantity of TMCS determined by a budget of TMCO;

$${λ}_{j}^{max}$$

is a price ceiling determined by a self-owned cost and a leasing preference of CFO j;

$${c}_{ω , j}^{H}$$

is a self-owned amortization cost converted to the dispatching cycle; ηⱼ is an adjustment coefficient;

$${λ}_{{n}_{e}}^{t {h}_{e}}$$

is an electricity price per kilowatt-hour when TMCS returns to a warehouse for recharging;

$${λ}_{n}^{th}$$

is a node electricity price for TMCS to participate in a day-ahead electricity energy market for energy arbitrage; n and v are operating locations of TMCS, i.e., energy arbitrage nodes that interact with the power grid;

$${P}_{ch , ω n}^{th} and {P}_{dch , ω n}^{th}$$

are charging and discharging power of TMCS ω at a time th for a node n;

$${ζ}_{ω , n}^{th} and {ζ}_{ω , nv}^{th}$$

are binary variables, which are 1 if ω is at a node n or moving on a path (n, v) at a time th, otherwise 0; thₑ and nₑ are a service end time of TMCS and a corresponding garage;

$${D}_{ω}^{e}$$

is a total travel distance in a dispatching period; vₐ is an average driving speed of TMCS;

$${c}_{e}^{tmc}$$

is an energy consumption per kilometer of TMCS;

$${c}_{ω}^{la}$$

is a labor cost of TMCS ω;

$${c}^{MDC}$$

is a marginal aging cost of a TMCS life cycle; qₜₕ is a calendar aging parameter of a TMCS battery pack; k is an annual serial number corresponding to commissioning of TMCS;

$${P}_{ch , ω}^{max} and {P}_{dch , ω}^{max}$$

are the maximum charging and discharging power;

$${I}_{ch , ω}^{th} and {I}_{dch , ω}^{th}$$

are Boolean variables, which are 1 if ω is charged or discharged at a time th, otherwise 0; η_{ch,ω} and η_{dch,ω} are charging and discharging efficiencies of TMCS;

$${E}_{ω}^{tmc}$$

is a capacity of TMCS ω;

$${SOC}_{ω}^{th}$$

is a SOC value of TMCS ω at the dispatching time th; and SOCₘₐₓ and SOCₘᵢₙ are the maximum and minimum SOC values of TMCS.

In this example, in the bi-level game model construction module 001, an optimization objective of the CFO two-stage DRCC model is to maximize utility, and an expression of the CFO two-stage DRCC model is as follows:

$$\{ \begin{matrix}\begin{matrix}max & min & max \\ y & {P}_{m}^{th} ∈ △ & d\end{matrix} {P}_{j} = {\sum }_{t ∈ T} ( {I}_{ω , t}^{ch} - {C}_{ω , T}^{L} - {C}_{ω , t}^{OM} ) \\ y = [ {v}_{ω , t}^{sp} , {v}_{ω , t}^{lp} ] \\ d = [ {P}_{dch , ω m}^{th} , {P}_{ch , ω n}^{th} , {ζ}_{ω , m}^{th} , {ζ}_{ω , n}^{th} , {ζ}_{ω , mu}^{th} , {ζ}_{ω , mn}^{th} , {I}_{ch , ω}^{th} ] \\ ω ∈ {Ω}_{j , t}^{c} = \{ {Ω}_{j , t}^{sp} ⋃ {Ω}_{j}^{lp} \}\end{matrix}$$

$${I}_{ω , t}^{ch} = {\sum }_{ω ∈ {Ω}_{j , t}^{c}} {\sum }_{th ∈ H} {λ}_{m}^{ch} {P}_{dch , ω m}^{th}$$

$${C}_{ω , t}^{L} = {\sum }_{ω ∈ {Ω}_{j , t}^{sp}} {v}_{ω , t}^{sp} {λ}_{j}^{sp} + {\sum }_{ω ∈ {Ω}_{j , t}^{lp}} {v}_{ω , t}^{lp} {λ}_{j}^{lp}$$

$${C}_{ω , t}^{OM} = {\sum }_{ω ∈ {Ω}_{j , t}^{c}} \{ {λ}_{{n}_{e}}^{{th}_{e}} {c}_{e}^{tmc} {D}_{ω}^{c} + {c}_{ω}^{l a} + {\sum }_{th ∈ H} {λ}_{n}^{th} {P}_{ch , ω n}^{th} \} + {{c}^{MDC} ( 1 + {r}_{0} )}^{k} \{ {q}_{th} + {\sum }_{ω ∈ {Ω}_{j , t}^{c}} {\sum }_{th ∈ H} ( {P}_{dch , ω m}^{th} + {P}_{ch , ω n}^{th} ) \}$$

where Pⱼ is a utility function of CFO j, defined as maximizing the profit of operator while ensuring charging service quality requirements;

$${Ω}_{j , t}^{c} , {Ω}_{j , t}^{sp} and {Ω}_{j}^{lp}$$

are a TMCS set of CFO j, along with its subsets for short-term leasing and long-term leasing;

$${P}_{m}^{th}$$

is an EV charging demand at a node m when selecting TMCS for charging; Δ is an ambiguity set of charging demand; y and d are optimization variables;

$${I}_{ω , t}^{ch}$$

is EV charging service revenue;

$${C}_{ω , t}^{L}$$

is a TMCS leasing cost;

$${C}_{ω , t}^{O M}$$

is a TMCS operating cost;

$${λ}_{m}^{c h}$$

is an EV charging electricity fee;

$${P}_{ch , ω n}^{t h} and {P}_{dch , ω m}^{t h}$$

are charging and discharging power of TMCS ω at the time th between nodes n and m; m and u are corresponding road network EV charging service nodes; and

$${D}_{ω}^{c}$$

is a TMCS travel distance calculated via the shortest-path method.

Constraints of the CFO two-stage DRCC model are as follows:

$${v}_{ω , t}^{s p} + {v}_{ω , t}^{l p} \leq 1 , ∀ ω ∈ {Ω}_{j , t}^{c} , t ∈ T$$

$${v}_{ω , t}^{l p} \leq {v}_{ω , τ}^{l p} , ∀ ω ∈ {Ω}_{j , t}^{c} , t ∈ T , τ ∈ T$$

$${v}_{ω , t}^{s p} \geq {v}_{ω , τ}^{s p} , ∀ ω ∈ {Ω}_{j , t}^{c} , t ∈ T , τ ∈ T$$

$${W}_{j , t}^{c} = {\sum }_{ω ∈ {Ω}_{j , t}^{c}} ( {v}_{ω , t}^{s p} + {v}_{ω , t}^{l p} )$$

$$⌈ \begin{matrix}max \\ Th ∈ t\end{matrix} \{ {P}_{m}^{t h} / {P}_{c s , ω}^{max} - {γ}_{j}^{c} \} ⌉ \leq {W}_{j , t}^{c} \leq {W}^{t m c}$$

$${\sum }_{m} {ζ}_{ω , n}^{t h} + {\sum }_{n} {ζ}_{ω , n}^{t h} + {\sum }_{m \neq u} {ζ}_{ω , mu}^{t h} + {\sum }_{m \neq n} {ζ}_{ω , mn}^{t h} = 1$$

$${\sum }_{m \neq u} {ζ}_{ω , mu}^{t h} + {\sum }_{m \neq n} {ζ}_{ω , m n}^{t} \geq {ζ}_{ω , m}^{t h + 1} - {ζ}_{ω , m}^{t h}$$

$${\sum }_{m \neq u} {ζ}_{ω , mn}^{t h} \geq {ζ}_{ω , n}^{t h + 1} - {ζ}_{ω , n}^{t h}$$

$${D}_{ω}^{c} = {v}_{a} {\sum }_{t h ∈ H} ( {\sum }_{m \neq u} {ζ}_{ω , mu}^{t h} + {\sum }_{m \neq n} {ζ}_{ω , mn}^{t h} )$$

$${ζ}_{ω , {n}_{e}}^{t {h}_{e}} = 1$$

$$0 \leq {P}_{ch , ω n}^{t h} \leq min ( {\sum }_{n} {ζ}_{ω , n}^{t h} , {I}_{c h , ω}^{t h} ) {P}_{c h , ω}^{max}$$

$${P}_{dch , ω m}^{t h} \leq {ζ}_{ω , m}^{t h} {P}_{cs , ω}^{max}$$

$${\sum }_{ω} {P}_{dch , ω m}^{t h} \geq max ( {P}_{m}^{t h} - {γ}_{j}^{c} {P}_{c s , ω}^{max} , 0 )$$

$${I}_{c h , ω}^{t h} \leq {\sum }_{n} {ζ}_{ω , n}^{t h}$$

$${SOC}_{ω}^{t h + 1} = {SOC}_{ω}^{t h} - \{ {\sum }_{t h ∈ H} {P}_{dch , ω n}^{t h + 1} / {η}_{dch , ω} - {η}_{c h , ω} {\sum }_{t h ∈ H} {P}_{c h , ω m}^{t h + 1} \} / {E}_{ω}^{t m c}$$

$${SOC}_{min} \leq {SOC}_{ω}^{t h} \leq {SOC}_{max}$$

$$where {W}_{j , t}^{c}$$

is a total number of leased units of CFO j at t;

$${P}_{c s , ω}^{max}$$

is the maximum output power of TMCS ω when providing EV charging service, and determined by the number of charging piles and rated power of TMCS;

$${γ}_{j}^{c}$$

is an EV charging demand response ratio of CFO j, which reflects charging service quality preference of CFO;

$${ζ}_{ω , mu}^{t h} and {ζ}_{ω , mn}^{t h}$$

are binary variables, if ω is moving on a path (m, u) or (m, n) at the time th,

$${ζ}_{ω , mu}^{t h} = 1 or {ζ}_{ω , mn}^{t h} = 1 ,$$

otherwise the two are 0.

In this example, in the bi-level game model solving module 003, in a process of solving the CFO two-stage DRCC model by the NC&CG algorithm, a solution problem of the CFO two-stage DRCC model is converted into an MP and an SP, and an expression of the MP is as follows:

$$\{ \begin{matrix}\begin{matrix}max \\ y ∈ Y\end{matrix} \begin{matrix}min \\ β ∈ Δ\end{matrix} \begin{matrix}max \\ d ( {d}_{1} , {d}_{2} ) ∈ D ( y , β )\end{matrix} ( {F}^{T} y + {G}^{T} d ) \\ {L}_{1} y \leq {ℚ}_{1} , {L}_{2} y + {J}_{1} β \leq {ℚ}_{2} , {S}_{1} {d}_{1} + {L}_{3} y = {ℚ}_{3} \\ s . t . {S}_{2} {d}_{1} + {L}_{4} y \leq {ℚ}_{4} , {V}_{1} {d}_{2} + {S}_{3} {d}_{1} + {L}_{5} y \leq {ℚ}_{5} \\ {V}_{2} {d}_{2} + {L}_{6} y + {J}_{2} β \leq {ℚ}_{6} , {V}_{3} {d}_{2} + {L}_{7} y = {ℚ}_{7}\end{matrix}$$

where F^{T} and G^{T} are constant coefficient matrices; y and d₁ are 0-1 decision variables for the first stage and the second stage of the above problem; d₂ is a continuous decision variable for the second stage optimization; β is an uncertain parameter of EV charging demand; F, G, L₁-L₇, J₁-J₂, S₁-S₃, V₁-V₃ are corresponding coefficient matrices; Q₁-Q₇ are constant column vectors; * represents a known quantity; s₁ and s₂ are the historical and current iteration numbers of the outer loop; x₁ is an auxiliary variable, representing the optimal value of the objective function in the second stage.

An expression of the SP is as follows:

$$SP \{ \begin{matrix}\begin{matrix}min \\ β\end{matrix} \begin{matrix}max \\ {d}_{1} , {d}_{2}\end{matrix} ( {F}^{T} {y}^{*} + {G}^{T} d ) \\ {L}_{2} {y}^{*} + {J}_{1} β \leq {ℚ}_{2} \\ {S}_{1} {d}_{1} + {L}_{3} {y}^{*} = {ℚ}_{3} \\ {S}_{2} {d}_{1} + {L}_{4} {y}^{*} = {ℚ}_{4} \\ s . t . {V}_{1} {d}_{2} + {S}_{3} {d}_{1} + {L}_{5} {y}^{*} \leq {ℚ}_{5} \to {τ}_{1} \geq 0 \\ {V}_{2} {d}_{2} + {L}_{6} {y}^{*} + {J}_{2} β \leq {ℚ}_{6} \to {τ}_{2} \geq 0 \\ {V}_{3} {d}_{2} + {L}_{7} {y}^{*} = {ℚ}_{7} \to {τ}_{3}\end{matrix}$$

where τ₁, τ₂ and τ₃ are dual variables corresponding to each constraint.

In this example, in the bi-level game model solving module 003, in a process of solving the SP, the SP is decomposed into an MPS and an SPS, and an expression of the MPS is as follows:

$$MPS \{ \begin{matrix}\begin{matrix}min \\ β\end{matrix} ( {F}^{T} {y}^{*} + {x}_{2} ) \\ {x}_{2} \geq {G}^{T} {d}_{2}^{{r}_{1}} \\ {L}_{2} {y}^{*} + {J}_{1} β \leq {ℚ}_{2} , {S}_{1} {d}_{1}^{{r}_{1}^{*}} + {L}_{3} {y}^{*} = {ℚ}_{3} \\ {S}_{2} {d}_{1}^{{r}_{1}^{*}} + {L}_{4} {y}^{*} \leq {ℚ}_{4} , {V}_{1} {d}_{2}^{{r}_{1}} + {S}_{3} {d}_{1}^{{r}_{1}^{*}} + {L}_{5} {y}^{*} \leq {ℚ}_{5} \\ {V}_{2} {d}_{2}^{{r}_{1}} + {L}_{6} {y}^{*} + {J}_{2} β \leq {ℚ}_{6} , {V}_{3} {d}_{2}^{{r}_{1}} + {L}_{7} {y}^{*} = {ℚ}_{7} \\ s . t . 0 \leq {τ}_{1}^{{r}_{1}} \leq {MI}_{1}^{{r}_{1}} , {V}_{1} {d}_{2}^{{r}_{1}} + {S}_{3} {d}_{1}^{{r}_{1}^{*}} + {L}_{5} {y}^{*} - {ℚ}_{5} \leq M ( 1 - {I}_{1}^{{r}_{1}} ) \\ 0 \leq {τ}_{2}^{{r}_{1}} \leq {MI}_{2}^{{r}_{1}} , {V}_{2} {d}_{2}^{{r}_{1}} + {L}_{6} {y}^{*} + {J}_{2} β - {ℚ}_{6} \leq M ( 1 - {I}_{2}^{{r}_{1}} ) \\ {ℒ}^{{r}_{1}} = G - {V}_{1}^{T} {τ}_{1}^{{r}_{1}} - {V}_{2}^{T} {τ}_{2}^{{r}_{1}} - {V}_{3}^{T} {τ}_{3}^{{r}_{1}} \\ 0 \leq {d}_{2}^{{r}_{1}} \leq {MI}_{0}^{{r}_{1}} , 0 \leq {ℒ}^{{r}_{1}} \leq M ( 1 - {I}_{0}^{{r}_{1}} ) , ∀ {r}_{1} \leq {r}_{2}\end{matrix}$$

where r₁ and r₂ are the historical and current iteration numbers of the inner loop; x₂ is an auxiliary variable representing the optimal value of the inner layer objective function; M is an extremely large positive real number;

$${I}_{0}^{{r}_{1}} , {I}_{1}^{{r}_{1}} and {I}_{2}^{{r}_{1}}$$

are 0-1 variables introduced in a linearization process of KKT complementary slackness conditions.

An expression of the SPS is as follows:

$$S P S \{ \begin{matrix}\begin{matrix}max \\ {d}_{1} , {d}_{2}\end{matrix} ( {F}^{T} {y}^{*} + {G}^{T} d ) \\ {S}_{1} {d}_{1} + {L}_{3} {y}^{*} = {ℚ}_{3} \\ {S}_{2} {d}_{1} + {L}_{4} {y}^{*} = {ℚ}_{4} \\ s . t . {V}_{1} {d}_{2} + {S}_{3} {d}_{1} + {L}_{5} {y}^{*} \leq {ℚ}_{5} \\ {V}_{2} {d}_{2} + {L}_{6} {y}^{*} + {J}_{2} {β}^{*} \leq {ℚ}_{6} \\ {V}_{3} {d}_{2} + {L}_{7} {y}^{*} = {ℚ}_{7}\end{matrix}$$

where β* is a realization value of uncertainty.

It is to be noted that the information interaction and execution process between the modules of the system are based on the same concept as the method example in Example 1 of the present disclosure, and the technical effects brought by the information interaction and execution process are the same as those of the method example of the present disclosure. For specific contents, reference may be made to the description in the method example shown above of the present disclosure, which will not be repeated here.

### Example 3

Example 3 of the present disclosure provides a non-transitory computer-readable storage medium, a program code of a BLO method based on a TMCS leasing mode is stored in the computer-readable storage medium, and the program code includes instructions for executing the BLO method based on a TMCS leasing mode according to Example 1 or any possible implementation mode thereof.

The computer-readable storage medium may be any available medium that can be accessed by a computer, or a data storage device including a server or a data center that integrates one or more available media. The available media may be magnetic media (e.g., floppy disk, hard disk, magnetic tape), optical media (e.g., digital versatile disc (DVD)), or semiconductor media (e.g., solid state disk (SSD)), etc.

### Example 4

Example 4 of the present disclosure provides electronic equipment, including a memory and a processor.

The processor and the memory communicate with each other through a bus; and the memory stores program instructions executable by the processor, and the processor calls the program instructions to execute the BLO method based on a TMCS leasing mode according to Example 1 or any possible implementation mode thereof.

Specifically, the processor can be implemented either by hardware or software. When implemented by hardware, the processor may be a logic circuit, an integrated circuit, or the like; and when implemented by software, the processor may be a general-purpose processor, which is implemented by reading software codes stored in a memory. The memory may be integrated into the processor, or may be located outside the processor and exist independently.

The above examples can be implemented in whole or in part by software, hardware, firmware or any combination thereof. The software can be implemented in whole or in part in the form of a computer program product. The computer program product includes one or more computer instructions. When the computer program instructions are loaded and executed on a computer, the processes or functions described in accordance with examples of the present disclosure are generated in whole or in part. The computer may be a general-purpose computer, a special-purpose computer, a computer network, or other programmable systems. The computer instructions may be stored in a computer-readable storage medium or transmitted from one computer-readable storage medium to another. For example, the computer instructions may be transmitted from one website, computer, server, or data center to another via wired means (such as coaxial cables, optical fibers, digital subscriber lines (DSL)) or wireless means (such as infrared, radio, and microwave).

Obviously, those skilled in the art will appreciate that the modules or steps of the present disclosure described above may be implemented in a general-purpose computing system, and the modules or steps may be centralized on a single computing system or distributed over a network of multiple computing systems. Alternatively, the modules or steps may be implemented in program code executable by the computing system, and may be stored in a storage system and executed by the computing system. In some cases, steps shown or described may be executed in an order different from that described herein, or each of steps may be fabricated into individual integrated circuit modules, or multiple modules or steps can be fabricated into a single integrated circuit module for implementation. Therefore, the present disclosure is not limited to any specific combination of hardware and software.

Although the present disclosure has been described in detail with reference to general description and specific examples, it is obvious to those skilled in the art that some modifications or improvements can be made on the basis of the present disclosure. Therefore, these modifications or improvements made without departing from the spirit of the present disclosure are within the claimed scope of the present disclosure.

1. A bi-level optimization (BLO) method based on a truck mobile charging station (TMCS) leasing mode, comprising the steps of:
establishing a bi-level game model based on a TMCS leasing mode, the bi-level game model comprising a truck mobile charging station operator (TMCO) model and a charging facility operator (CFO) two-stage distributionally robust chance-constrained optimization (DRCC) model; and with an optimization objective of the TMCO model being to maximize net revenue, and an optimization objective of the CFO two-stage DRCC model being to maximize utility;
introducing a Wasserstein distance distributionally robust model based on chance constraints through a distributionally robust optimization (DRO) strategy; and balancing economy and robustness of the bi-level game model via the Wasserstein distance distributionally robust model; and
solving the TMCO model through a genetic algorithm (GA) to obtain a revenue-maximizing configuration and a leasing price; and solving the CFO two-stage DRCC model via a nested column-and-constraint generation (NC&CG) algorithm to obtain a leasing plan and a scheduling strategy with maximum utility.

2. The BLO method based on a TMCS leasing mode according to claim 1, wherein parameters of the TMCO model comprise:
leasing income of TMCS; a revenue function of TMCO, representing a difference between a total income from leasing and energy arbitrage and costs of investment, operation and maintenance, and losses; profit of TMCS from energy arbitrage; investment and operation and maintenance costs of TMCS; set of TMCS, as well as subsets for short-term leasing and long-term leasing; leasing period and planning cycle; number ω and total quantity of TMCS; energy storage battery cost, energy storage battery replacement cost, charging pile and converter cost, cost of other accessories for trucks and containers, garage cost, and operation and maintenance cost of TMCS ω; conversion coefficients for TMCS system, energy storage batteries, and maintenance costs; service life of energy storage batteries and TMCS system; discount rate converted to the planning cycle; and replacement serial number and total replacement times of the energy storage batteries; and
operational constraint parameters of the TMCO model comprise:
dispatching time and a dispatching cycle; maximum configuration quantity of TMCS determined by a budget of TMCO; price ceiling determined by self-owned cost and leasing preference of CFO j (where j is the number of CFO); self-owned amortization cost converted to the dispatching cycle; adjustment coefficient; electricity price per kilowatt-hour when TMCS returns to a warehouse for recharging; node electricity price for TMCS participating in a day-ahead electricity energy market for energy arbitrage; operating location of TMCS, i.e., an energy arbitrage node interacting with a power grid; charging and discharging power of TMCS ω at a time th for a node n; service end time of TMCS and corresponding garage; total travel distance in a dispatching period; average driving speed of TMCS; energy consumption per kilometer of TMCS; labor cost of TMCS ω; marginal aging cost of TMCS life cycle; calendar aging parameter of TMCS battery pack; annual serial number corresponding to commissioning of TMCS; maximum charging and discharging power; charging and discharging efficiency of TMCS; capacity of TMCS ω; (SOC) value of TMCS at the dispatching time; and maximum and minimum SOC values of TMCS.

3. The BLO method based on a TMCS leasing mode according to claim 2, wherein parameters of the CFO two-stage DRCC model comprise:
utility function of CFO j, defined as maximizing the profit of operator while ensuring charging service quality requirements; set of TMCS for CFO j, as well as subsets for short-term leasing and long-term leasing; electric vehicle (EV) charging demand at a node m when selecting TMCS for charging; ambiguity set of charging demand; optimization variables; EV charging service revenue; TMCS leasing cost; TMCS operating cost; EV charging electricity fee; charging and discharging power of TMCS ω at the time th between nodes n and m; corresponding road network EV charging service nodes; and TMCS driving distance obtained by the shortest path method; and
constraint parameters of the CFO two-stage DRCC model comprise:
total number of leased units of CFO j at t; maximum output power of TMCS ω when providing EV charging services, determined by the number of charging piles and rated power of TMCS; and EV charging demand response ratio of CFO j.

4. The BLO method based on a TMCS leasing mode according to claim 3, wherein in a process of solving the CFO two-stage DRCC model by the NC&CG algorithm, a solution problem of the CFO two-stage DRCC model is converted into a master problem (MP) and a subproblem (SP).

5. The BLO method based on a TMCS leasing mode according to claim 4, wherein in a process of solving the SP, the SP is decomposed into a master problem subset (MPS) and a subproblem subset (SPS).

6. A BLO device based on a TMCS leasing mode, adopting the BLO method based on a TMCS leasing mode according to claim 1, comprising:
a bi-level game model construction module, configured to establish a bi-level game model based on a TMCS leasing mode, the bi-level game model comprising a TMCO model and a CFO two-stage DRCC model; and with an optimization objective of the TMCO model being to maximize net revenue, and an optimization objective of the CFO two-stage DRCC model being to maximize utility;
a Wasserstein distance distribution robust model processing module, configured to introduce a Wasserstein distance distributionally robust model based on chance constraints through a DRO strategy; and balance economy and robustness of the bi-level game model via the Wasserstein distance distributionally robust model; and
a bi-level game model solving module, configured to solve the TMCO model through a GA to obtain a revenue-maximizing configuration and a leasing price; and solve the CFO two-stage DRCC model via an NC&CG algorithm to obtain a leasing plan and a scheduling strategy with maximum utility.

7. A BLO device based on a TMCS leasing mode, adopting the BLO method based on a TMCS leasing mode according to claim 2, comprising:
a bi-level game model construction module, configured to establish a bi-level game model based on a TMCS leasing mode, the bi-level game model comprising a TMCO model and a CFO two-stage DRCC model; and with an optimization objective of the TMCO model being to maximize net revenue, and an optimization objective of the CFO two-stage DRCC model being to maximize utility;
a Wasserstein distance distribution robust model processing module, configured to introduce a Wasserstein distance distributionally robust model based on chance constraints through a DRO strategy; and balance economy and robustness of the bi-level game model via the Wasserstein distance distributionally robust model; and
a bi-level game model solving module, configured to solve the TMCO model through a GA to obtain a revenue-maximizing configuration and a leasing price; and solve the CFO two-stage DRCC model via an NC&CG algorithm to obtain a leasing plan and a scheduling strategy with maximum utility.

8. A BLO device based on a TMCS leasing mode, adopting the BLO method based on a TMCS leasing mode according to claim 3, comprising:
a bi-level game model construction module, configured to establish a bi-level game model based on a TMCS leasing mode, the bi-level game model comprising a TMCO model and a CFO two-stage DRCC model; and with an optimization objective of the TMCO model being to maximize net revenue, and an optimization objective of the CFO two-stage DRCC model being to maximize utility;
a Wasserstein distance distribution robust model processing module, configured to introduce a Wasserstein distance distributionally robust model based on chance constraints through a DRO strategy; and balance economy and robustness of the bi-level game model via the Wasserstein distance distributionally robust model; and
a bi-level game model solving module, configured to solve the TMCO model through a GA to obtain a revenue-maximizing configuration and a leasing price; and solve the CFO two-stage DRCC model via an NC&CG algorithm to obtain a leasing plan and a scheduling strategy with maximum utility.

9. A BLO device based on a TMCS leasing mode, adopting the BLO method based on a TMCS leasing mode according to claim 4, comprising:
a bi-level game model construction module, configured to establish a bi-level game model based on a TMCS leasing mode, the bi-level game model comprising a TMCO model and a CFO two-stage DRCC model; and with an optimization objective of the TMCO model being to maximize net revenue, and an optimization objective of the CFO two-stage DRCC model being to maximize utility;
a Wasserstein distance distribution robust model processing module, configured to introduce a Wasserstein distance distributionally robust model based on chance constraints through a DRO strategy; and balance economy and robustness of the bi-level game model via the Wasserstein distance distributionally robust model; and
a bi-level game model solving module, configured to solve the TMCO model through a GA to obtain a revenue-maximizing configuration and a leasing price; and solve the CFO two-stage DRCC model via an NC&CG algorithm to obtain a leasing plan and a scheduling strategy with maximum utility.

10. A BLO device based on a TMCS leasing mode, adopting the BLO method based on a TMCS leasing mode according to claim 5, comprising:
a bi-level game model construction module, configured to establish a bi-level game model based on a TMCS leasing mode, the bi-level game model comprising a TMCO model and a CFO two-stage DRCC model; and with an optimization objective of the TMCO model being to maximize net revenue, and an optimization objective of the CFO two-stage DRCC model being to maximize utility;
a Wasserstein distance distribution robust model processing module, configured to introduce a Wasserstein distance distributionally robust model based on chance constraints through a DRO strategy; and balance economy and robustness of the bi-level game model via the Wasserstein distance distributionally robust model; and
a bi-level game model solving module, configured to solve the TMCO model through a GA to obtain a revenue-maximizing configuration and a leasing price; and solve the CFO two-stage DRCC model via an NC&CG algorithm to obtain a leasing plan and a scheduling strategy with maximum utility.

11. The BLO device based on a TMCS leasing mode according to claim 6, wherein in the bi-level game model construction module, an optimization objective of the TMCO model is to maximize net income; and parameters of the TMCO model comprise:
leasing income of TMCS; a revenue function of TMCO, representing a difference between a total income from leasing and energy arbitrage and costs of investment, operation and maintenance, and losses; profit of TMCS from energy arbitrage; investment and operation and maintenance costs of TMCS; set of TMCS, as well as subsets for short-term leasing and long-term leasing; leasing period and planning cycle; number ω and total quantity of TMCS; energy storage battery cost, energy storage battery replacement cost, charging pile and converter cost, cost of other accessories for trucks and containers, garage cost, and operation and maintenance cost of TMCS ω; conversion coefficients for TMCS system, energy storage batteries, and maintenance costs; service life of energy storage batteries and TMCS system; discount rate converted to the planning cycle; and replacement serial number and total replacement times of the energy storage batteries; and
operational constraint parameters of the TMCO model comprise:
dispatching time and a dispatching cycle; maximum configuration quantity of TMCS determined by a budget of TMCO; price ceiling determined by self-owned cost and leasing preference of CFO j (where j is the number of CFO); self-owned amortization cost converted to the dispatching cycle; adjustment coefficient; electricity price per kilowatt-hour when TMCS returns to a warehouse for recharging; node electricity price for TMCS participating in a day-ahead electricity energy market for energy arbitrage; operating location of TMCS, i.e., an energy arbitrage node interacting with a power grid; charging and discharging power of TMCS ω at a time th for a node n; service end time of TMCS and corresponding garage; total travel distance in a dispatching period; average driving speed of TMCS; energy consumption per kilometer of TMCS; labor cost of TMCS ω; marginal aging cost of TMCS life cycle; calendar aging parameter of TMCS battery pack; annual serial number corresponding to commissioning of TMCS; maximum charging and discharging power; charging and discharging efficiency of TMCS; capacity of TMCS ω; SOC value of TMCS at the dispatching time; and maximum and minimum SOC values of TMCS.

12. The BLO device based on a TMCS leasing mode according to claim 7, wherein in the bi-level game model construction module, an optimization objective of the TMCO model is to maximize net income; and parameters of the TMCO model comprise:
leasing income of TMCS; a revenue function of TMCO, representing a difference between a total income from leasing and energy arbitrage and costs of investment, operation and maintenance, and losses; profit of TMCS from energy arbitrage; investment and operation and maintenance costs of TMCS; set of TMCS, as well as subsets for short-term leasing and long-term leasing; leasing period and planning cycle; number ω and total quantity of TMCS; energy storage battery cost, energy storage battery replacement cost, charging pile and converter cost, cost of other accessories for trucks and containers, garage cost, and operation and maintenance cost of TMCS ω; conversion coefficients for TMCS system, energy storage batteries, and maintenance costs; service life of energy storage batteries and TMCS system; discount rate converted to the planning cycle; and replacement serial number and total replacement times of the energy storage batteries; and
operational constraint parameters of the TMCO model comprise:
dispatching time and a dispatching cycle; maximum configuration quantity of TMCS determined by a budget of TMCO; price ceiling determined by self-owned cost and leasing preference of CFO j (where j is the number of CFO); self-owned amortization cost converted to the dispatching cycle; adjustment coefficient; electricity price per kilowatt-hour when TMCS returns to a warehouse for recharging; node electricity price for TMCS participating in a day-ahead electricity energy market for energy arbitrage; operating location of TMCS, i.e., an energy arbitrage node interacting with a power grid; charging and discharging power of TMCS ω at a time th for a node n; service end time of TMCS and corresponding garage; total travel distance in a dispatching period; average driving speed of TMCS; energy consumption per kilometer of TMCS; labor cost of TMCS ω; marginal aging cost of TMCS life cycle; calendar aging parameter of TMCS battery pack; annual serial number corresponding to commissioning of TMCS; maximum charging and discharging power; charging and discharging efficiency of TMCS; capacity of TMCS ω; SOC value of TMCS at the dispatching time; and maximum and minimum SOC values of TMCS.

13. The BLO device based on a TMCS leasing mode according to claim 8, wherein in the bi-level game model construction module, an optimization objective of the TMCO model is to maximize net income; and parameters of the TMCO model comprise:
leasing income of TMCS; a revenue function of TMCO, representing a difference between a total income from leasing and energy arbitrage and costs of investment, operation and maintenance, and losses; profit of TMCS from energy arbitrage; investment and operation and maintenance costs of TMCS; set of TMCS, as well as subsets for short-term leasing and long-term leasing; leasing period and planning cycle; number ω and total quantity of TMCS; energy storage battery cost, energy storage battery replacement cost, charging pile and converter cost, cost of other accessories for trucks and containers, garage cost, and operation and maintenance cost of TMCS ω; conversion coefficients for TMCS system, energy storage batteries, and maintenance costs; service life of energy storage batteries and TMCS system; discount rate converted to the planning cycle; and replacement serial number and total replacement times of the energy storage batteries; and
operational constraint parameters of the TMCO model comprise:
dispatching time and a dispatching cycle; maximum configuration quantity of TMCS determined by a budget of TMCO; price ceiling determined by self-owned cost and leasing preference of CFO j (where j is the number of CFO); self-owned amortization cost converted to the dispatching cycle; adjustment coefficient; electricity price per kilowatt-hour when TMCS returns to a warehouse for recharging; node electricity price for TMCS participating in a day-ahead electricity energy market for energy arbitrage; operating location of TMCS, i.e., an energy arbitrage node interacting with a power grid; charging and discharging power of TMCS ω at a time th for a node n; service end time of TMCS and corresponding garage; total travel distance in a dispatching period; average driving speed of TMCS; energy consumption per kilometer of TMCS; labor cost of TMCS ω; marginal aging cost of TMCS life cycle; calendar aging parameter of TMCS battery pack; annual serial number corresponding to commissioning of TMCS; maximum charging and discharging power; charging and discharging efficiency of TMCS; capacity of TMCS ω; SOC value of TMCS at the dispatching time; and maximum and minimum SOC values of TMCS.

14. The BLO device based on a TMCS leasing mode according to claim 9, wherein in the bi-level game model construction module, an optimization objective of the TMCO model is to maximize net income; and parameters of the TMCO model comprise:
leasing income of TMCS; a revenue function of TMCO, representing a difference between a total income from leasing and energy arbitrage and costs of investment, operation and maintenance, and losses; profit of TMCS from energy arbitrage; investment and operation and maintenance costs of TMCS; set of TMCS, as well as subsets for short-term leasing and long-term leasing; leasing period and planning cycle; number ω and total quantity of TMCS; energy storage battery cost, energy storage battery replacement cost, charging pile and converter cost, cost of other accessories for trucks and containers, garage cost, and operation and maintenance cost of TMCS ω; conversion coefficients for TMCS system, energy storage batteries, and maintenance costs; service life of energy storage batteries and TMCS system; discount rate converted to the planning cycle; and replacement serial number and total replacement times of the energy storage batteries; and
operational constraint parameters of the TMCO model comprise:
dispatching time and a dispatching cycle; maximum configuration quantity of TMCS determined by a budget of TMCO; price ceiling determined by self-owned cost and leasing preference of CFO j (where j is the number of CFO); self-owned amortization cost converted to the dispatching cycle; adjustment coefficient; electricity price per kilowatt-hour when TMCS returns to a warehouse for recharging; node electricity price for TMCS participating in a day-ahead electricity energy market for energy arbitrage; operating location of TMCS, i.e., an energy arbitrage node interacting with a power grid; charging and discharging power of TMCS ω at a time th for a node n; service end time of TMCS and corresponding garage; total travel distance in a dispatching period; average driving speed of TMCS; energy consumption per kilometer of TMCS; labor cost of TMCS ω; marginal aging cost of TMCS life cycle; calendar aging parameter of TMCS battery pack; annual serial number corresponding to commissioning of TMCS; maximum charging and discharging power; charging and discharging efficiency of TMCS; capacity of TMCS ω; SOC value of TMCS at the dispatching time; and maximum and minimum SOC values of TMCS.

15. The BLO device based on a TMCS leasing mode according to claim 10, wherein in the bi-level game model construction module, an optimization objective of the TMCO model is to maximize net income; and parameters of the TMCO model comprise:
leasing income of TMCS; a revenue function of TMCO, representing a difference between a total income from leasing and energy arbitrage and costs of investment, operation and maintenance, and losses; profit of TMCS from energy arbitrage; investment and operation and maintenance costs of TMCS; set of TMCS, as well as subsets for short-term leasing and long-term leasing; leasing period and planning cycle; number ω and total quantity of TMCS; energy storage battery cost, energy storage battery replacement cost, charging pile and converter cost, cost of other accessories for trucks and containers, garage cost, and operation and maintenance cost of TMCS ω; conversion coefficients for TMCS system, energy storage batteries, and maintenance costs; service life of energy storage batteries and TMCS system; discount rate converted to the planning cycle; and replacement serial number and total replacement times of the energy storage batteries; and
operational constraint parameters of the TMCO model comprise:
dispatching time and a dispatching cycle; maximum configuration quantity of TMCS determined by a budget of TMCO; price ceiling determined by self-owned cost and leasing preference of CFO j (where j is the number of CFO); self-owned amortization cost converted to the dispatching cycle; adjustment coefficient; electricity price per kilowatt-hour when TMCS returns to a warehouse for recharging; node electricity price for TMCS participating in a day-ahead electricity energy market for energy arbitrage; operating location of TMCS, i.e., an energy arbitrage node interacting with a power grid; charging and discharging power of TMCS ω at a time th for a node n; service end time of TMCS and corresponding garage; total travel distance in a dispatching period; average driving speed of TMCS; energy consumption per kilometer of TMCS; labor cost of TMCS ω; marginal aging cost of TMCS life cycle; calendar aging parameter of TMCS battery pack; annual serial number corresponding to commissioning of TMCS; maximum charging and discharging power; charging and discharging efficiency of TMCS; capacity of TMCS ω; SOC value of TMCS at the dispatching time; and maximum and minimum SOC values of TMCS.

16. The BLO device based on a TMCS leasing mode according to claim 11, wherein in the bi-level game model construction module, parameters of the CFO two-stage DRCC model comprise:
utility function of CFO j, defined as maximizing the profit of operator while ensuring charging service quality requirements; set of TMCS for CFO j, as well as subsets for short-term leasing and long-term leasing; EV charging demand at a node m when selecting TMCS for charging; ambiguity set of charging demand; optimization variables; EV charging service revenue; TMCS leasing cost; TMCS operating cost; EV charging electricity fee; charging and discharging power of TMCS ω at the time th between nodes n and m; corresponding road network EV charging service nodes; and TMCS driving distance obtained by the shortest path method; and
constraint parameters of the CFO two-stage DRCC model comprise:
total number of leased units of CFO j at t; maximum output power of TMCS ω when providing EV charging services, determined by the number of charging piles and rated power of TMCS; and EV charging demand response ratio of CFO j, reflecting charging service quality preference of CFO.

17. The BLO device based on a TMCS leasing mode according to claim 12, wherein in the bi-level game model construction module, parameters of the CFO two-stage DRCC model comprise:
utility function of CFO j, defined as maximizing the profit of operator while ensuring charging service quality requirements; set of TMCS for CFO j, as well as subsets for short-term leasing and long-term leasing; EV charging demand at a node m when selecting TMCS for charging; ambiguity set of charging demand; optimization variables; EV charging service revenue; TMCS leasing cost; TMCS operating cost; EV charging electricity fee; charging and discharging power of TMCS ω at the time th between nodes n and m; corresponding road network EV charging service nodes; and TMCS driving distance obtained by the shortest path method; and
constraint parameters of the CFO two-stage DRCC model comprise:
total number of leased units of CFO j at t; maximum output power of TMCS ω when providing EV charging services, determined by the number of charging piles and rated power of TMCS; and EV charging demand response ratio of CFO j, reflecting charging service quality preference of CFO.

18. The BLO device based on a TMCS leasing mode according to claim 13, wherein in the bi-level game model construction module, parameters of the CFO two-stage DRCC model comprise:
utility function of CFO j, defined as maximizing the profit of operator while ensuring charging service quality requirements; set of TMCS for CFO j, as well as subsets for short-term leasing and long-term leasing; EV charging demand at a node m when selecting TMCS for charging; ambiguity set of charging demand; optimization variables; EV charging service revenue; TMCS leasing cost; TMCS operating cost; EV charging electricity fee; charging and discharging power of TMCS ω at the time th between nodes n and m; corresponding road network EV charging service nodes; and TMCS driving distance obtained by the shortest path method; and
constraint parameters of the CFO two-stage DRCC model comprise:
total number of leased units of CFO j at t; maximum output power of TMCS ω when providing EV charging services, determined by the number of charging piles and rated power of TMCS; and EV charging demand response ratio of CFO j, reflecting charging service quality preference of CFO.

19. The BLO device based on a TMCS leasing mode according to claim 16, wherein in the bi-level game model solving module, in a process of solving the CFO two-stage DRCC model by the NC&CG algorithm, a solution problem of the CFO two-stage DRCC model is converted into an MP and an SP.

20. The BLO device based on a TMCS leasing mode according to claim 19, wherein in the bi-level game model solving module, in a process of solving the SP, the SP is decomposed into an MPS and an SPS.
